(19) United States
(12) Patent Application Publication
(10) Pub. No.: US 2015/0012533 A1
(43) Pub. Date: Jan. 8, 2015

(54) METHOD AND CLIENT DEVICE FOR ACCESSING WEBPAGE

(71) Applicant: TENCENT TECHNOLOGY (SHENZHEN) COMPANY LIMITED, Shenzhen (CN)

(72) Inventors: DONG WANG, Shenzhen (CN); MEI QIN, Shenzhen (CN)

(73) Assignee: TENCENT TECHNOLOGY (SHENZHEN) COMPANY LIMITED

(21) Appl. No.: 14/462,812

(22) Filed: Aug. 19, 2014

Related U.S. Application Data
(63) Continuation of application No. PCT/CN2014/078466, filed on May 27, 2014.

(30) Foreign Application Priority Data
Jul. 2, 2013 (CN) 2013102751693

(51) Int. Cl. G06F 17/30; H04L 29/08

(52) U.S. Cl. CPC G06F 17/30864; H04L 67/02
USPC 707/736

(57) ABSTRACT

Methods and device for accessing a webpage are provided. A client obtains a first URL (uniform resource locator) according to a request for accessing a webpage and updates the first URL to generate a second URL. The second URL contains one or more pre-stored data items which are pre-stored in the client, and the second URL is configured to load information corresponding to the one or more pre-stored data items to the webpage to be accessed. The client accesses the webpage via the second URL. A client device includes a first obtaining unit, a first updating unit, and an accessing unit.

### CROSS-REFERENCES TO RELATED APPLICATIONS

This application is a continuation application of PCT Patent Application No. PCT/CN2014/078466, filed on May 27, 2014, which claims priority to Chinese Patent Application No. 2013102751693, filed on Jul. 2, 2013, the entire content of both of which is incorporated herein by reference.

### FIELD OF THE DISCLOSURE

The present disclosure relates to the field of communication technology and, more particularly, relates to methods and client devices for accessing webpage.

### BACKGROUND

In current network communication technology, a client often accesses a website using URL (Uniform Resource Locator). The URL may be expressed according to standard URL syntax. Accessing a webpage based on the URL may need to use a network server to pull webpage data required by the website to form entire webpage to be eventually displayed on a browser of the client.

FIG. 1 shows a conventional method of accessing a webpage. As shown in FIG. 1, conventional methods of accessing a webpage may include: the client submits a request for accessing a webpage to be accessed through a first URL, establishes data connection between the webpage and a server, and requests the server for information that the webpage needs to load; and the server pulls webpage data corresponding to information to be loaded through a CGI (Common Gateway Interface) interface or a CGI program, sends the pulled webpage data to the webpage, and sends the entire webpage to the client for the client to display in the browser.

As noted, when accessing the webpage according to existing webpage accessing methods, data connection has to be established between the webpage and the network server, while the network server needs to perform multiple data transmission tasks. When a small amount of clients accesses a webpage at the same time, the network server generally has enough resource to establish data connection and perform data transmission tasks. However, when a large amount of clients accesses the webpage at the same time, the network server may need to simultaneously establish multiple data connections and to undertake the significant burden of data transmission. This may cause overloading of the network server.

On the other hand, the client may need to wait till data interactions between the webpage and the network server are completed. As such, the response time of the webpage has to be overly long, when the client accesses the webpage.

### BRIEF SUMMARY OF THE DISCLOSURE

One aspect or embodiment of the present disclosure includes a method for accessing a webpage. A client obtains a first URL (uniform resource locator) according to a request for accessing a webpage and updates the first URL to generate a second URL. The second URL contains one or more pre-stored data items which are pre-stored in the client, and the second URL is configured to load information corresponding to the one or more pre-stored data items to the webpage to be accessed. The client accesses the webpage via the second URL.

The updating of the first URL includes matching a URL identification item of the first URL with pre-stored identification items of a data table. The URL identification item is recorded inside or outside the first URL. The data table is pre-stored in the client. Each of the pre-stored identification items is individually stored in the data table or correspondingly stored in the data table corresponding to the one or more pre-stored data items. The updating of the first URL further includes updating the pre-stored data item corresponding to the matched identification item of the data table into the first URL, when the pre-stored identification items contain an identification item matched with the URL identification item.

Another aspect or embodiment of the present disclosure includes a client device including a first obtaining unit, a first updating unit, and an accessing unit. The first obtaining unit is configured to obtain a first URL according to a request for accessing a webpage. The first updating unit is configured to update the first URL to form a second URL. The second URL contains one or more pre-stored data items which are pre-stored in the client, and is configured to load information corresponding to the one or more pre-stored data items to the webpage to be accessed. The accessing unit is configured to access the webpage via the second URL.

The first updating unit includes: a matching module and an updating module. The matching module is configured to match a URL identification item of the first URL with pre-stored identification items of a data table. The URL identification item is recorded inside or outside the first URL, the data table is pre-stored in the client, and each of the pre-stored identification items is individually stored in the data table or correspondingly stored in the data table corresponding to the one or more pre-stored data items. The updating module is configured to update the pre-stored data item corresponding to the matched identification item of the data table into the first URL, when the pre-stored identification items contain an identification item matched with the URL identification item.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an implementing environment for conventional methods of accessing webpage;

FIG. 2 depicts an exemplary method for accessing a webpage consistent with various disclosed embodiments;

FIG. 3 depicts an exemplary implementing environment for a webpage accessing method consistent with various disclosed embodiments;

FIG. 4 depicts another exemplary method for accessing a webpage consistent with various disclosed embodiments;

FIG. 5 depicts another exemplary method for accessing a webpage consistent with various disclosed embodiments;

FIG. 6 depicts another exemplary method for accessing a webpage consistent with various disclosed embodiments;

FIG. 7 depicts another exemplary method for accessing a webpage consistent with various disclosed embodiments;

FIG. 8 depicts another exemplary method for accessing a webpage consistent with various disclosed embodiments;

FIG. 9 depicts another exemplary method for accessing a webpage consistent with various disclosed embodiments;

FIG. 10 depicts another exemplary method for accessing a webpage consistent with various disclosed embodiments;

FIG. 11 depicts another exemplary method for accessing a webpage consistent with various disclosed embodiments;

FIG. 12 depicts another exemplary method for accessing a webpage consistent with various disclosed embodiments;

FIG. 13 depicts an exemplary client consistent with various disclosed embodiments;

FIG. 14 depicts an exemplary first updating unit of a client consistent with various disclosed embodiments;

FIG. 15 depicts another exemplary client consistent with various disclosed embodiments;

FIG. 16 depicts another exemplary client consistent with various disclosed embodiments;

FIG. 17 depicts an exemplary environment incorporating certain disclosed embodiments; and

FIG. 18 depicts an exemplary computer system consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

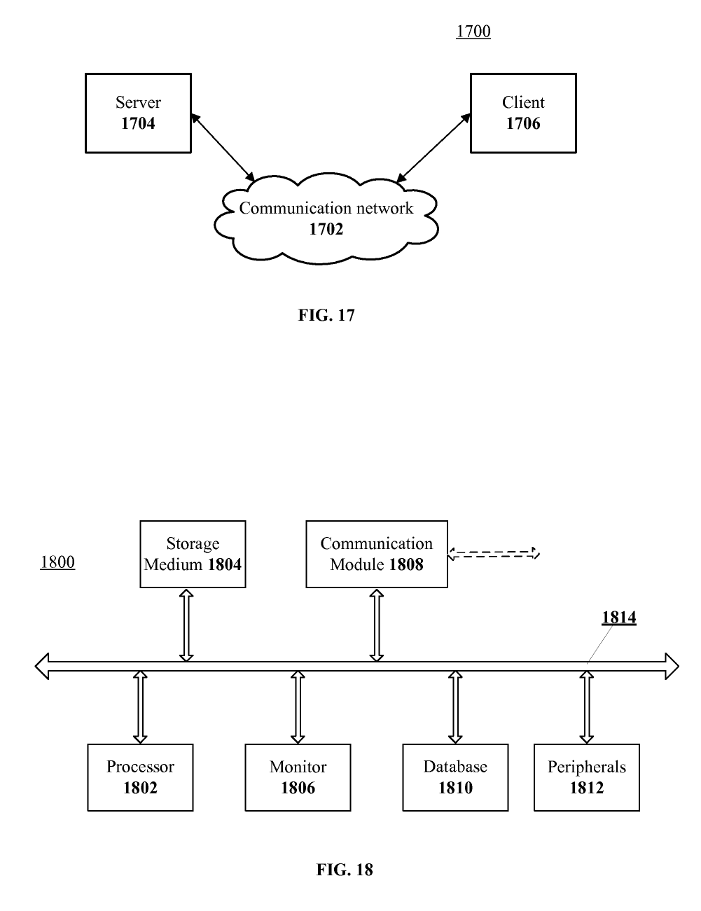

FIGS. 1-16 depict exemplary methods and devices for accessing a webpage in accordance with various disclosed embodiments. The exemplary methods and device can be implemented, for example, in an exemplary environment 1700 as shown in FIG. 17.

FIG. 17 illustrates an exemplary environment 1700 incorporating certain disclosed embodiments of the present invention. As shown in FIG. 17, environment 1700 may include a server 1704, a client 1706, and a communication network 1702. The server 1704 and the client 1706 may be coupled through the communication network 1702 for information exchange, such as Internet searching. Although only one client 1706 and one server 1704 is shown in the environment 1700, any number of clients 1706 or servers 1704 may be included, and other devices may also be included.

Communication network 1702 may include any appropriate type of communication network for providing network connections to the server 1704 and client 1706 or among multiple servers 1704 or clients 1706. For example, communication network 1702 may include the Internet or other types of computer networks or telecommunication networks, either wired or wireless.

A client, as used herein, may refer to any appropriate user terminal with certain computing capabilities, such as a personal computer (PC), a work station computer, a server computer, a hand-held computing device (tablet), a smart phone or mobile phone, or any other user-side computing device. In various embodiments, the client can also include a client device.

A server, as used herein, may refer one or more server computers configured to provide certain server functionalities, such as database management and search engines. A server may also include one or more processors to execute computer programs in parallel.

The server 1704 and/or the client 1706 can include a computer system 1800 as shown in FIG. 18. The computer system 1800 may include a processor 1802, a storage medium 1804, a monitor 1806, a communication module 1808, a database 1810, peripherals 1812, and one or more bus 1814 to couple the devices together. Certain devices may be omitted and other devices may be included.

Processor 1802 may include any appropriate processor or processors. Further, processor 1802 can include multiple cores for multi-thread or parallel processing. Storage medium 1804 may include memory modules, such as ROM, RAM, and flash memory modules, and mass storages, such as CD-ROM, U-disk, removable hard disk, etc. Storage medium 1804 may store computer programs for implementing various processes, when executed by processor 1802.

Further, peripherals 1812 may include I/O devices such as keyboard and mouse, and communication module 1808 may include network devices for establishing connections through the communication network 1702. Database 1810 may include one or more databases for storing certain data and for performing certain operations on the stored data, such as webpage browsing, database searching.

In operation, client 1706 may cause server 1704 to perform certain actions, such as an Internet search or other database operations. Server 1704 may be configured to provide structures and functions for such actions and operations. More particularly, server 1704 may include a data searching system for real-time database searching. The real-time database searching functionality may be realized by separating a server database into a plurality of databases each having a fixed upper limit on the database capacity, i.e., maximum capacity. Thus, instead of creating indices for a single large database, which may be a large number, indices of the plurality of smaller databases can be created with substantially less amount of time.

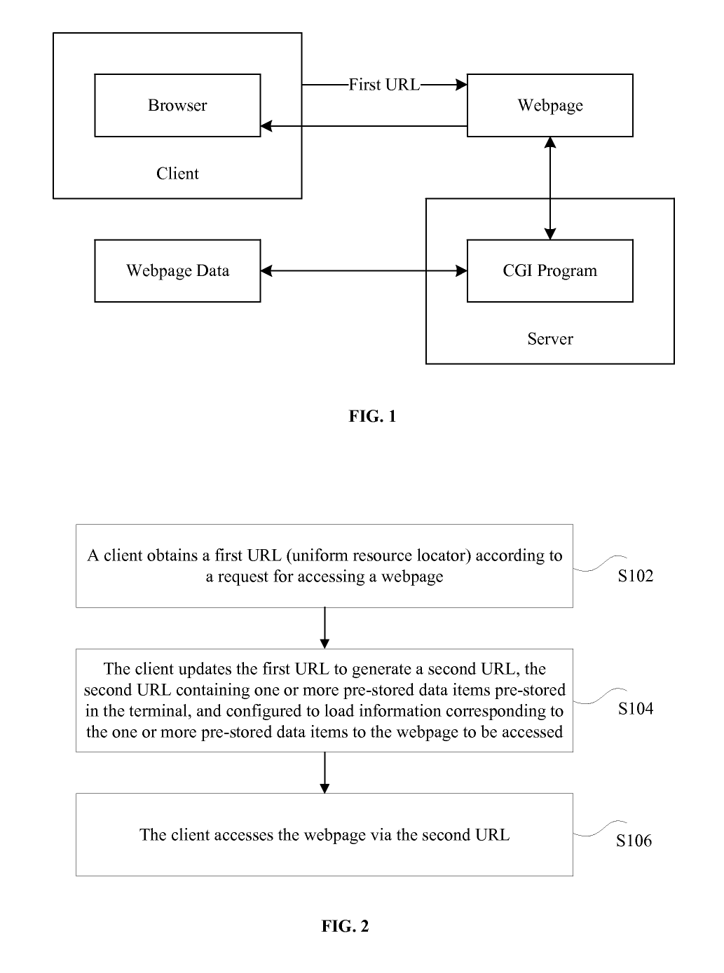

According to various embodiments, a method for accessing webpage is provided, e.g., as shown in FIG. 2. In Step S102 of FIG. 2, a client obtains a first URL (uniform resource locator) according to a request for accessing a webpage (a webpage accessing request).

In Step S104, the client updates the first URL to generate a second URL. The second URL contains one or more pre-stored data items which are pre-stored in the client, and the second URL is configured to load information corresponding to the one or more pre-stored data items to the webpage to be accessed. In Step S106, the client accesses the webpage via the second URL.

According to the method for accessing webpage, in Step S102, the client can obtain the first URL according to the request for accessing webpage (or the webpage accessing request). Specifically, in a general condition, the request for accessing webpage can be shown as a clicked identification of a certain webpage link on the user interface provided by the client. For example, in various embodiments, the capture and identification of clicking by mouse on a section of texts having the URL hyperlink on the interface can form the request for accessing webpage, and the URL corresponding to the hyperlink can be truncated in the client as the first URL. Of course, the above-mentioned webpage link may not appear on the characters, but on other suitable user interface elements, for example icons, images, video pictures, etc.

However, methods for requesting to access the webpage and/or the method for obtaining the first URL are not limited and any suitable methods can be encompassed herein. For example, the methods for requesting to access the webpage can also include confirmation of the webpage address inputted in the address bar of the browser, while the client can read the webpage address as the first URL. In fact, in various embodiments, the request for accessing webpage may be independent from the signal from a computer inputting device and read by the client. For example, the request for accessing webpage can be automatically generated by running an application in the client, to form a popup-page on the client interface (for example, for accessing a navigation page) to obtain the URL of the popup-page as the first URL by the client. In various embodiments, the source of the request for accessing webpage may not be limited to the above-mentioned client for accessing the webpage. For example, under some environment for interactions between a client and a server, the request for accessing webpage may be from the server-side, and in this case, the first URL may be obtained from outside of the client.

According to the disclosed method for accessing webpage, in Step S104, the client may update the first URL to form the second URL. The second URL contains one or more pre-stored data items which are pre-stored in the client, and is configured to load information corresponding to the one or more pre-stored data items to the webpage to be accessed. For example, the above information may be the word information. In various embodiments, the client can directly update code of English character, or the Chinese character corresponding to the user ID into the first URL to form the second URL, in Step S106, to display the user name or nickname in a pre-set location of the target webpage. However, in various embodiments, the above information can be configured including other types of information. For example, in a scenario, the client may update the configuration item code corresponding to the user configuration into the first URL. For example for a pre-set parameter that can be identified by the webpage, the parameter “0” is configured to denote white webpage background, the parameter “1” is configured to denote blue webpage background, and the parameter of “2” is configured to denote green webpage background. The above value item can further be transmitted to the webpage by the updated second URL to display the corresponding background color on the webpage. Of course, the above-described examples are for illustration purposes, other suitable examples can be encompassed without limitations.

It should be appreciated that, various suitable methods for updating the first URL for forming the second URL may be used without limitation. Note that the first URL and second URL described in the disclosure for illustration purposes. For example, a “first” and a “second” should be understood as a URL and another different URL. For example, in some embodiments, only “URL” may be described, while no any “second URL” is described. For example, the first URL can be replaced with “URL before update”, while the second URL can be replaced with “URL after update” or “updated URL”.

According to the disclosed method for accessing webpage, in Step 106, the client can access the webpage through the second URL. In some embodiments, the first URL and the second URL can point to a same webpage. In other embodiments, the first URL and the second URL can point to a different webpage. For example, after updating the path portion of the first URL, the webpage directed by the formed second URL can be different from the first URL. Note that the updating method of the first URL and the specific format of the second URL can be configured according to the processing requirement of the request for accessing webpage requested by the client.

As such, in various embodiments, different from directly using the first URL to access a webpage, the client can first locally update the first URL, (e.g., assign a value to one or more parameters of the first URL), after updating, then use the formed second URL to access the webpage. Because the webpage can directly read the parameter values from the second URL without temporarily establishing the data connection between the webpage and the network server to pull the corresponding webpage data, the burden of network server is decreased. Meanwhile, the response speed for accessing the webpage on the client-side is increased. In various embodiments, the first URL can further be updated through any other suitable methods to achieve the same or similar technology effect.

As described above, conventional methods include: the client submits a request for accessing a webpage to be accessed through a first URL, establishes data connection between the webpage and a server, and requests the server for information that the webpage needs to load; and the server pulls webpage data corresponding to information to be loaded through a CGI (Common Gateway Interface) interface or a CGI program, sends the pulled webpage data to the webpage, and sends the entire webpage to the client for the client to display in the browser.

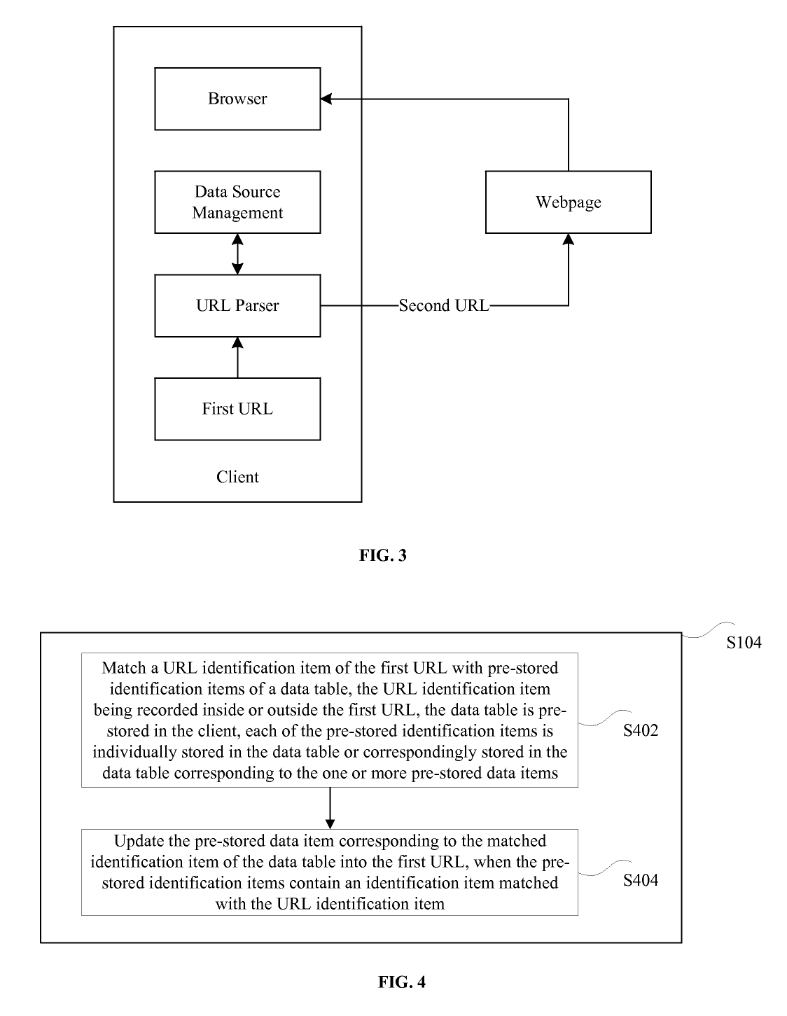

As disclosed, FIG. 3 depicts an exemplary implementing environment for implementing a webpage accessing method consistent with various disclosed embodiments. For example, a client can access a webpage using the exemplary implementing environment in FIG. 3. In the method, the client obtains a first URL according to a request for accessing a webpage; requests and pulls the webpage data from the local data source management through the URL parser; updates the first URL according to the pulled webpage data to form the second URL through the URL parser; and/or submits a webpage accessing request through the second URL. The second URL contains information to be loaded by the webpage to be accessed corresponding to the webpage data.

Compared with conventional methods for accessing a webpage, in the disclosed methods for accessing a webpage, when the webpage is being accessed, the data connection between the webpage and the server in existing technology is eliminated, and the multiple data transmission participated by the server is also eliminated. The burden of the network server caused by client accessing webpage can be significantly decreased. This solves problems in conventional technology, which often cause the network server to be overloaded when obtaining webpage information through the network server. In addition, in various embodiments, the client can realize normal accessing to the webpage through the locally provided pre-stored data, while there is no need to wait for a long time for accomplishing data interactions used for transmitting the webpage information between the webpage and the network server in conventional technologies. The response time of the webpage to be accessed can be decreased.

Optionally, in various embodiments, referring to FIG. 4, Step S104 includes exemplary steps as follows.

In Step S402 of FIG. 4, a URL identification item of the first URL is matched with the pre-stored identification items of a data table. The URL identification item is recorded inside or outside the first URL. The data table is pre-stored in the client. Each of the pre-stored identification items is individually stored in the data table or correspondingly stored in the data table corresponding to the one or more pre-stored data items.

In Step S404, when the pre-stored identification items contain an identification item matched with the URL identification item, the pre-stored data item corresponding to the matched identification item of the data table is updated into the first URL.

In one embodiment, the data table locally stored in the client can be used to store the pre-stored data item configured to update the first URL into the second URL as depicted in Step S104. In addition to the pre-stored data item, the data table can be configured to store the pre-stored identification item having corresponding relationship with the pre-stored data item. Each of the pre-stored identification items may correspond to one or more pre-stored data items. In various embodiments, in the data table stored by the client, at a certain point/moment, a pre-stored data item corresponding to each of one or more of the pre-stored identification items may have a content that is empty. That is, at this point/moment, the data table does not contain the pre-stored data item corresponding to that one or more pre-stored identification items.

For better understanding, Table 1 shows a storage structure of the pre-stored identification item and the pre-stored data item in the data table. Table 1 is configured to show a sort of data table locally stored in the client and corresponding to a first user. The first column is configured to show the name of information loaded in the webpage to be accessed. The second column is configured to show the pre-stored identification item, the third column is configured to show the pre-stored data item, and the forth column is configured to show variable name corresponding to the pre-stored data item stored in the client.

In one embodiment, referring to the first column of Table 1, information loaded in the webpage to be accessed includes: Black List, Nick Name, Age, Zodiac, Background Music, etc. All these information can correspond to the first user with the user serial number of “001”.

TABLE 1

| Webpage | | | Data Item |
|---|---|---|---|
| Information | Pre-Stored | Pre-Stored Data | Variable |
| Name | Identification Item | Item | Name |
| Black List | bl | 002 | uin.BL.0 |
| | | 003 | uin.BL.1 |
| Age | age | 26 | uin.AGE |
| Zodiac | co | 0 | uin.CO |
| Nick Name | nickname | Tom | uin.NICKNAME |
| Background | bgm | a0b1c2 | uin.BGM |
| Music | | | |

In various embodiment, the information loaded in the webpage to be accessed corresponding to the pre-stored data item(s) may be various types. Such information loaded in the webpage can be characters, texts, audio files, and/or video files without limitations.

Optionally, as shown in the second column of Table 1, the pre-stored identification item(s) respectively corresponding to the above information can be configured as: “b1”, “age”, “co”, “nickname”, and “bgm”.

As disclosed, the pre-stored identification item can be an English letter or combination of letters. Other suitable methods can be used. For example, the pre-stored identification item can include character(s) or character string(s) other than letter(s), for example, number(s), special character(s), and/or any combination of the above. The disclosure is not limited in any manner. In addition, as described above, the pre-stored identification item can be configured to be a character string corresponding to the information name loaded in the webpage. However, any suitable configuration regulation can be used for the pre-stored identification item(s). For example, in various embodiments, the “uni=001” can be stored in another data table as the pre-stored identification item, and the pre-stored data item shown in the third column of Table 1 can be stored in the same data table corresponding to the pre-stored data item, without limitations.

Optionally, referring to the third column of Table 1, the pre-stored data item corresponding to the pre-stored identification item can respectively be: “002”, “003”, “26”, “0”, “Tom”, and “a0b1c2”.

The pre-stored data items “002” and “003”, corresponding to the pre-stored identification item of “b1”, can respectively be user serial numbers of the second user and the third user in the black list set by the first user.

The pre-stored data item of “26”, corresponding to the pre-stored identification item of “age”, can be the age of the first user. The pre-stored data item of “0”, corresponding to the pre-stored identification item of “co”, can be the zodiac of the first user. The numerical value from 0 to 11 can be used to denote twelve Zodiacs, respectively. For example, the numeric value “0” denotes Aquarius.

The pre-stored data item “Tom”, corresponding to the pre-stored identification item of “nickname”, can be a nickname of the first user. The pre-stored data item “a0b1c2”, corresponding to the pre-stored identification item of “bgm”, can be the file name of the background music set by the first user.

In various embodiments, the pre-stored data item may include various types. The pre-stored data item can be a numerical value, a character string, or other suitable data format, for example, Boolean quantity etc. In addition, as of the interaction between the client and the webpage, the pre-stored data item can be directly displayed on a page of the webpage, e.g., to show the data item of “26” denoting user age and the data item of “Tom” denoting user nickname, to give code for some webpage loading information that can be identified by the webpage, to show the data item of “0” denoting user Zodiac, to give the directive information of other sources to be called by the webpage, to show the data item of “a0b1c2” denoting the file name of the background music to be loaded by the webpage, and/or to show serial number(s) and accessing path(s) of files of other type or the data of the format stated and required by the data interactive interface standard.

On the other hand, referring to Table 1, the pre-stored identification item can correspond to one data item, and/or can correspond to multiple data items. For example, the pre-stored identification item “b1” can correspond to the data item of “002” and “003” simultaneously to show that the second user and the third user in the black list set by the first user. Further, the data item corresponding to the pre-stored identification item “b1” can include nicknames of the second user and the third user for the webpage to be accessed to simultaneously obtain and display the serial number and the nickname information of users in the black list. In addition, in various embodiments, the pre-stored identification item can be configured to have a user serial number of “001” for the first user, and a corresponding pre-stored data item can include collection of the data items shown by the third column of Table 1.

On the other hand, in various embodiments, the content of a pre-stored data item corresponding to one or more pre-stored identification items in the data table may be empty. For example, in some cases, in a data table similar to Table 1, identification item pre-set by the client (e.g., the pre-stored identification item shown in the second column of Table 1) can be included. But some of the pre-stored identification items (e.g., the identification item of “age” corresponding to user age) can correspond to data items that are still not downloaded into the client, such that the data table similar to Table 1 may not contain the pre-stored data item corresponding to the pre-stored identification item “age”. In this case, subsequent updating scheme to the pre-stored data item of this data table can be described in great details later in this disclosure.

Optionally, referring to the forth column of Table 1, the variable name used by the pre-stored data item stored in the client can be respectively configured to “uin.BL.0”, “uin.BL.1”, “uin.AGE”, “uin.CO”, “uin.NICKNAME”, and “uin.BGM”.

In various embodiments, the variable name used by the pre-stored data item can be divided into two or three sections. For example, the first section “uin” can be a numerical value that equal to the user serial number “001” of the first user, used to be differentiated from other pre-stored data items corresponding to other users (e.g., the second user or the third user) stored in other data tables. In this case, by identifying the first section of the variable name, the client can realize the accurate calling of the pre-stored data item corresponding to a certain user, and update the pre-stored data item into the first URL in Step S402. The second URL can be formed and used for loading corresponding information in the webpage to be accessed, such that response can be made to multiple different users through a same one webpage.

In the above-mentioned variable names, the second section can be denoted by a capital letter portion and can be of the same name as the pre-stored identification item corresponding to the pre-stored data item, to form a corresponding relationship between the pre-stored data item and the pre-stored identification item. Of course, the corresponding relationship between the pre-stored data item and the pre-stored identification item can be established by any other suitable methods without limitations.

The above-mentioned variable names can further include a third section, for example “0” and “1” in “uin.BL.0” and “uin.BL.1”, configured to direct to multiple pre-stored data items corresponding to a same one pre-stored identification item. In various embodiments, the variable names used by the pre-stored data items can further include more character strings without limitations.

Note that, in the above case, as the pre-stored identification item can be directly read from the variable names of variables valued from the pre-stored data item, the client may not need to assign a fixed storage space for the pre-stored identification item. This can increase the usage efficiency of the storage space. Of course, the described herein are examples for illustration purposes, various embodiments can include any other implement methods and their variables without limitation.

According to the disclosed method for accessing webpage, in Step S402, the URL identification item of the first URL can be matched with pre-stored identification items in the data table, the URL identification item may be configured to mark the data item to be replaced in the first URL. Generally, according to the above matching result, the data item which is successfully matched in the first URL can be used as the URL identification item. In some embodiments, the first URL can first be parsed according to the pre-set configuration to obtain the URL identification item. For example, according to the URL format, the first URL can be split to obtain the URL identification item.

On the other hand, the URL identification item can be located inside or outside of the first URL. In various embodiments, one portion of the URL identification item can be from the inside of the first URL, and another portion of the URL identification item can be from the outside of the first URL.

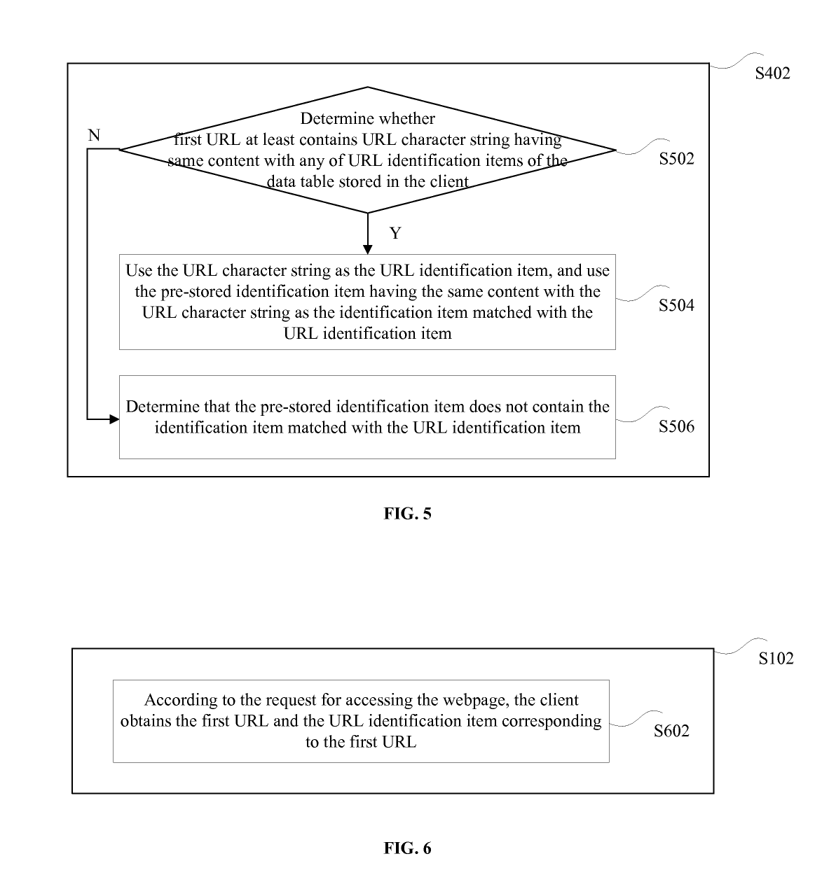

In Step S402, the first URL can be directly matched with the data table stored in the client to obtain the URL identification item that is inside of the first URL. Optionally, referring to FIG. 5, the matching step can be implemented to include the following exemplary Steps.

In Step S502, it is determined whether the first URL at least contains the URL character string having the same content with any of the URL identification items of the data table stored in the client.

When it is determined that the first URL at least contains the URL character string having the same content with any of the URL identification items of the data table stored in the client, Step S504 can be implemented. When it is determined that the first URL does not contain the URL character string having the same content with any of the URL identification items of the data table stored in the client, Step S506 can be implemented.

In Step S504, the URL character string is used as the URL identification item, and the pre-stored identification item having the same content with the URL character string is used as the identification item matched with the URL identification item.

In Step S506, it is determined that the pre-stored identification item does not contain the identification item matched with the URL identification item.

For example, for the data table in Table 1, it is determined whether the first URL contains the character string same as the pre-stored identification item of “b1”, “age”, “co”, “nickname”, or “bmg” shown in the second column of Table 1. When the first URL contains the character string is determined, it is considered the matching is successful, and Step S504 can be implemented. For example, such character string in the first URL, i.e., the URL character string, can be used as the URL identification item; the location of the URL character string in the first URL can be recorded; or according to the first URL character string, the first URL can be split into two sections two sections before and after the character string. When the first URL does not contain the character string, it is considered the matching is unsuccessful, and Step S506 can be implemented. It can then be determined that the pre-stored identification item does not contain the matched identification item depicted in Step S404. Of course, for avoiding the misjudgment occurs due to use of pure letter identification item, the pre-stored identification item can be set as “b1=”, “age=”, “co=”, “nickname=”, or “bgm=”, or the pre-stored identification item can be pre-processed during the matching process.

In addition, according to the determination result after the processes in Step S504 or S506, it is selected in Step S404 whether to implement the Steps for updating the pre-stored data item in the data table corresponding to the matched identification item into the first URL.

In various embodiments, the URL identification item can further be recorded in the outside of the first URL. For example, referring to FIG. 6, Step S102 can include the following exemplary steps.

In Step S602, according to the request for accessing the webpage, the client obtains the first URL and the URL identification item corresponding to the first URL.

Optionally, in Step S102, in addition to obtaining the first URL according to the request for accessing the webpage, the client can further obtain the other information corresponding to the request for accessing the webpage from the outside of the first URL. For example, the webpage to be accessed is configured to display related data of the first user, while when detecting the request for accessing the webpage, the client can obtain the user serial number of “001” corresponding to the first user outside of the obtained first URL, and use the serial number of “001” as the URL identification item, to match with the pre-stored identification item stored in the data table by the client. Of course, in various embodiments, the disclosed methods can be combined.

For example, as an optional implementing method, the obtained URL identification item outside of the first URL (for example, the above-described user serial number of “001” corresponding to the first user) can be added into the first URL, or be combined with the first URL, and then matched with the pre-stored identification item of the data table.

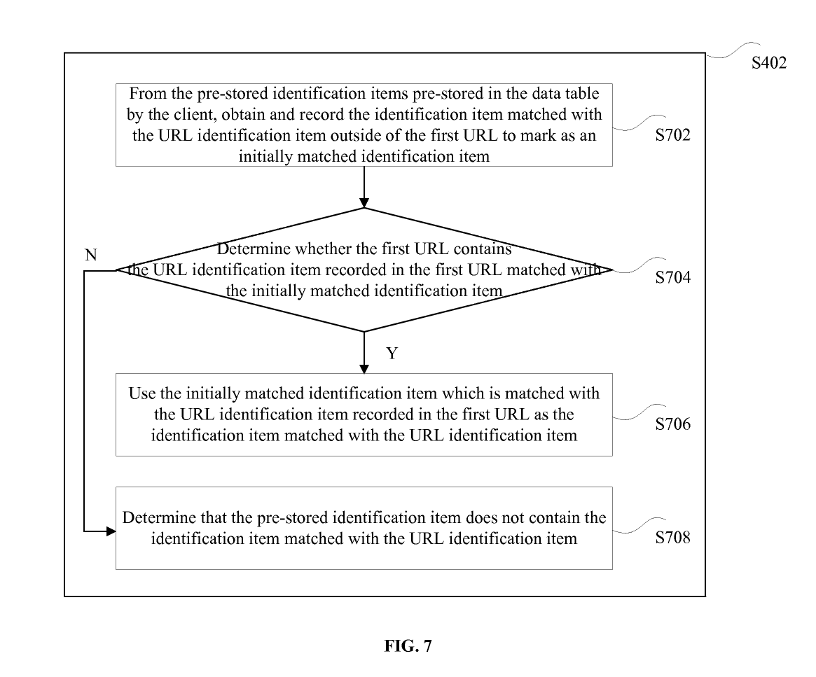

In another optional method, referring to FIG. 7, Step S402 can include the following exemplary steps.

In Step S702, from the pre-stored identification items pre-stored in the data table of the client, the identification item matched with the URL identification item outside of the first URL is obtained and recorded, and marked as an initially matched identification item.

In Step S704, it is determined whether the first URL contains the URL identification item recorded in the first URL matched with the initially matched identification item. When it is determined that the first URL contains the URL identification item, Step S706 can be implemented. When it is determined that the first URL does not contain the URL identification item, Step S708 can be implemented.

In Step S706, the initially matched identification item which is matched with the URL identification item recorded in the first URL is used as the identification item matched with the URL identification item. In Step S708, it is determined that the pre-stored identification item does not contain the identification item matched with the URL identification item.

TABLE 2

| Webpage | Pre-Stored | Pre-Stored Data | Data Item |
|---|---|---|---|
| Information | Identification Item | Item | Variable Name |
| Black List | 001.Bl | 002 | Uin.Bl.0 |
| | | 003 | Uin.BL.1 |
| Age | 001.Age | 26 | Uin.AGE |

According to the exemplary method in FIG. 7, Table 2 is another table list corresponding to a first user having a serial number “001”, as similarly described in Table 1.

In Table 2, the pre-stored identification item can be set as a structure including two sections to implement the matching processes for the URL identification item recorded inside and outside of the first URL as depicted in Steps S702 and S704.

In one embodiment, according to Step S702, the pre-stored identification item shown in the second column of Table 3 can be matched with the URL identification item recorded in the outside of the first URL, to obtain the initially matched identification item. Optionally, according to the first section (i.e., “001”) of the pre-stored identification item of the data table shown as Table 2, the pre-stored identification item can be matched with the URL identification item outside of the first URL. In a first scenario of this case, the URL identification item outside of the first URL obtained by the client can be “002”. No identification item matched with the URL identification item “002” can be found from the pre-stored identification items. That is, the initially matched identification item is not contained. In a second scenario of this case, the URL identification item outside of the first URL obtained by the client can be “001”, which matches with the pre-stored identification items “001.b1” and “001.age” in the data table shown in Table 2. The pre-stored identification items “001.b1” and “001.age” can then be marked as initially matched identification items.

In the above-mentioned second scenario, according to Step S704, the first URL can be matched with the initially matched identification item, i.e., the first URL can be matched with the above-mentioned initially matched identification items “001.b1” and “001.age”. Optionally, the second section of the above two identification items (i.e., “b1” and “age”) can be matched with the URL identification item of the first URL. As an optional method, it can be determined whether the first URL contains the character string the same as “b1” or “age”. When the first URL contains the character string, Step S706 can be implemented. When the first URL does not contain the character string, Step S708 can be implemented. Of course, for avoiding mis-determination, the first URL can further be determined whether contains the character string same as “b1=” or “age=”.

In addition, according to the determination result processed in Step S704 or S706, it is selected in Step S404 whether to implement the Steps for updating the pre-stored data item in the data table corresponding to the matched identification item into the first URL.

Any suitable methods for matching the URL identification item with the pre-stored identification item may be used and encompassed. For example, the client can be pre-set according to specific applications.

According to the disclosed method for accessing webpage, in Step S404, when the pre-stored identification item contains the identification item matched with the URL identification item, the pre-stored identification item corresponding to the matched identification item of the data table is updated into the first URL. It is noted that, the implementing condition of Step S404 contains the corresponding relationship with the matching result of Step S402. That is, in Step S404, according to the matching result of Step S402, it can be selected whether to implement the Steps of updating the pre-stored data item corresponding to the matched identification item of the data table into the first URL.

It should be noted that, in Step S404, the updated first URL can be directly used as the second URL, to implement the accessing of the webpage in Step S106. In other embodiments, the updated first URL can be further processed using any suitable methods.

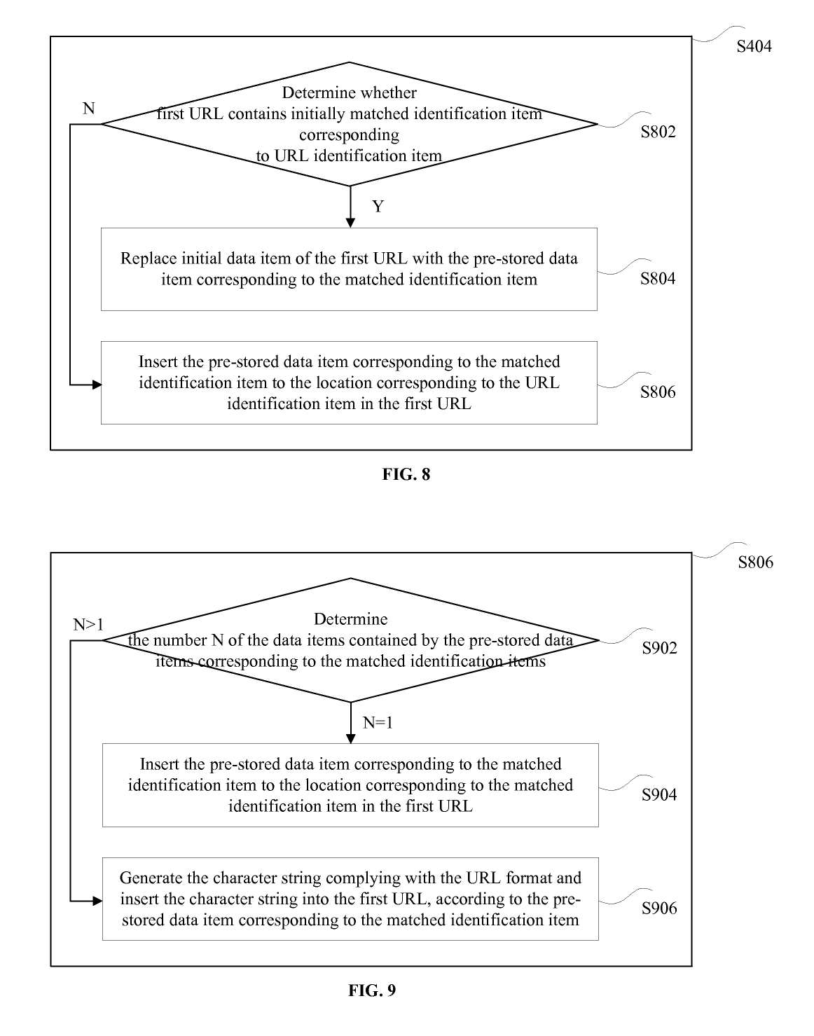

On the other hand, in Step S404, the operation of updating the pre-stored data item corresponding to the matched identification item in the data table into the first URL can be implemented by any suitable methods without limitations. For example, an exemplary method can include: updating an entire first URL (that is, according to the pre-stored data item corresponding to the matched identification item and the URL format, directly generating the second URL), and replacing the first URL with the second URL. Of course, other suitable implementing method can be used for the updating operation, for example as shown in FIG. 8. In FIG. 8, the Step S404 can be implemented by the following exemplary Steps.

In Step S802, it is determined whether the first URL contains the initially matched identification item corresponding to the URL identification item. When it is determined that the first URL contains the initially matched identification item, Step S804 can be implemented. When it is determined that the first URL does not contain the initially matched identification item, Step S806 can be implemented.

In Step S804, the initial data item of the first URL is replaced with the pre-stored data item corresponding to the matched identification item. In Step S806, the pre-stored data item corresponding to the matched identification item is inserted into the location corresponding to the URL identification item in the first URL.

In various embodiments, the first URL can contain the URL identification item, but cannot contain the initial data item corresponding to one or more of the URL identification item. For example, the parameter portion of the first URL can include the character fragment in a format of “&parameter name=&”, where “&” is configured to show separation between these two parameters. In one exemplary scenario, when the character string corresponding to the “parameter name” has been stored in the data table of the client as one member of the pre-stored identification item, then after a successful matching in Step S402, the portion of “parameter name” can be marked as the URL identification item. As the content of the data item corresponding to the first URL is empty, the first URL is determined that does not contain the initial data item corresponding to the URL identification item in Step S802. Step S806 can then be implemented.

In the above exemplary scenario, in Step S806, the pre-stored data item corresponding to the matched identification item can be inserted into the location corresponding to the URL identification item in the first URL. For example, the pre-stored data item (e.g., “parameter values”) corresponding to the matched identification item in the data table can be inserted into a location (e.g., the location set after a first “=” after the “parameter name”) corresponding to the URL identification item of “parameter name” in the first URL. In various embodiments, the character string corresponding to “parameter name=” can be used as the pre-stored identification item to be stored in the data table. After a successful matching, the “parameter name=” can be marked as the URL identification item, such that the pre-stored data item of “parameter name” corresponding to the pre-stored identification item can be directly inserted after the URL identification item.

In addition, in various embodiments, referring to FIG. 9, Step S806 further includes exemplary steps as following. In Step S902, it is determined the number N of the data items contained by the pre-stored data items corresponding to the matched identification items. When the number N=1, Step S904 can be implemented. When the number N>1, Step S906 can be implemented.

In Step S904, the pre-stored data item corresponding to the matched identification item is inserted to the location corresponding to the matched identification item in the first URL.

In Step S906, the character string complying with the URL format is generated, and the character string is inserted into the first URL, according to the pre-stored data item corresponding to the matched identification item.

In one embodiment, the pre-stored data item corresponding to the pre-stored identification item may be one or more. Referring to Table 1, the pre-stored data item corresponding to the pre-stored identification item of “nickname” is one item: “Tom”. In one scenario, after the matching process in Step S402, the pre-stored identification item of “nickname” becomes the matched identification item, then the number “N” of the data item contained by the pre-stored data item corresponding to the matched identification item N=1. Step S904 can be implemented.

In the above scenario, in Step S904, the pre-stored data item corresponding to the matched identification item can be inserted into the location corresponding to the matched identification item in the first URL. Step S904 can be implemented similar as Step S806.

Referring to Table 1, the pre-stored data item corresponding to the pre-stored identification item of “b1” has two items: “002” and “003”. In one scenario, after the matching process in Step S402, the pre-stored identification item of “b1” becomes the matched identification item, then the number “N” of the data item contained in the pre-stored data item corresponding to the matched identification item N=2. Step S906 can be implemented.

In Step S906, according to the pre-stored data item corresponding to the matched identification item, the character string complying with the URL format can be generated, and the character string can be inserted into the first URL. For example, according to the pre-stored data items of “002” and “003” corresponding to the matched identification item of “b1”, the character string (e.g., “&b1_{—}0=002&b1_{—}1=003”) complying with the URL format can be generated and inserted into the first URL, to form the second URL used for displaying the second user and the third user in the black list on the webpage to be accessed. For example, the generated character string complying with the URL format can further comply with the rule of data interactive interface standard for the second URL to be identified by the webpage. Of course, this is an example for illustration purposes. In various embodiments, the number “N” of the data item contained in the one or more pre-stored data items corresponding to the matched identification item can be N=3 or more.

On the other hand, in various embodiments, the first URL contains not only the URL identification item, but also the corresponding initial data item. For example, the path portion of the first URL can include “/folder name/request_uin/”, where “/” is configured to show a separation between the two path nodes, and “request_uin” can be pre-set character used for reading the user serial number. In one scenario, when the URL identification item recorded outside of the first URL obtained by the client has the user serial number “001” of the first user, and the URL identification item “001” has been stored in the data table of the client as one member of the pre-stored identification item. Then after a successful matching in Step S402, as the first URL contains the corresponding initial data item of “request_uin”, Step S804 can be implemented.

In Step S804, the initial data item of the first URL can be replaced with the pre-stored data item corresponding to the matched identification item. For example, the initial data item of “request_uin” can be replaced with the pre-stored data item of “001” corresponding to the matched identification item, to form the second URL including the “folder name/001” and to display information stored in the path corresponding to the first user in the webpage.

In one embodiment, the pre-stored data item can be same as the pre-stored identification item, for example, the same as “001”, to practically realize the importing the information from the URL identification item recorded outside of the first URL into the first URL.

Further, in various embodiments, based on different URL identification items (e.g., “002” or “003”) obtained by the client, the initial data item is replaced to form the second URL, which indeed points out the webpages under different paths. Such webpages can use the same source code, which may be called a same page or a different page without limitations.

It should be appreciated that the above described implementing environment may be modified or altered. Generally, in one embodiment, the first URL may contain a URL identification item, and/or may contain URL identification items that are not obtained by the client in Steps S602 and S402. Further, in a case that a URL contains URL identification item, the URL may or may not contain initial data items corresponding to the URL identification items. A portion of the URL identification item(s) may contain corresponding initial data item, while another portion of the URL identification item(s) may not contain corresponding initial data item, without limitation.

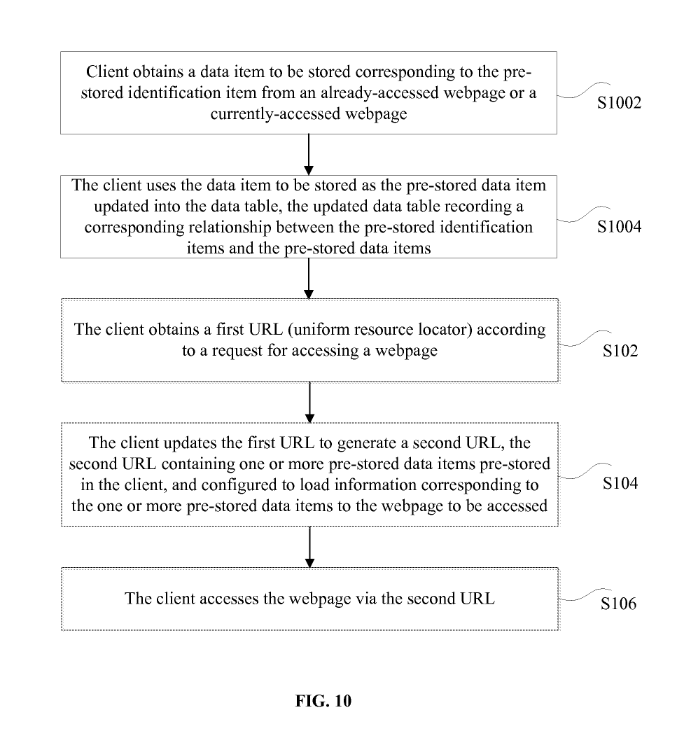

Optionally, referring to FIG. 10, before performing Step S402, the disclosed methods for accessing webpage can further include the following exemplary steps. In Step S1002, the client obtains a data item to be stored corresponding to the pre-stored identification item from an already-accessed webpage or a currently-accessed webpage.

In Step S1004, the client uses the data item to be stored as the pre-stored data item updated into the data table, the updated data table recording a corresponding relationship between the pre-stored identification items and the pre-stored data items.

According to the disclosed method for accessing webpage, before performing Step S402, and, in Step S1002, the data item to be stored corresponding to the pre-stored identification stored in the data table by the client can be obtained from the already-accessed webpage or the currently-accessed webpage by the client. For example, the data item to be stored can be further configured to denote the data item to be stored into the data table of the client, to initialize or refresh the pre-stored data item of the data table in Step S1004. Similar to the pre-stored data item depicted in Table 1, the data item to be stored may include multiple types, for example Boolean quantity, numerical value, character string, etc.

In the example of Table 1, in one scenario, when the pre-stored data item of the data table shown in Table 1 is empty, i.e., the data table does not contain the data item corresponding to the pre-stored identification shown by the second column of Table 1, the client can pull the data item corresponding to the pre-stored identification item from the webpage through the Step S1002 as the data item to be stored, and in Step S1004, the data item to be stored pulled from the webpage can be used as the pre-stored data item to add into the data table. The data table can then be improved to be more complete such that, when accessing the webpage according to the disclosed method for accessing webpage, a successful calling of the pre-stored data item can then be realized in Step S404. In one embodiment, the implementing condition of Step S1002 and S1004 can further be set as any suitable conditions or no implementing condition is set to obtain the data corresponding to the pre-stored identification item of the data table from each webpage accessed by the client, and/or to refresh the data table according to the data item to be stored obtained from each accessing.

Specifically, as an optional implementing condition, referring to FIG. 11, before Step S1002, the following exemplary Steps can be included. In Step S1102, it is determined whether the data table contains the pre-stored data item corresponding to the pre-stored identification item. When it is determined that the data table does not contain the pre-stored data item, Step S1002 and S1004 can be implemented.

In Step S1002, when the data table contains the pre-stored data item corresponding to the pre-stored identification item, i.e., the pre-stored data item may not be updated temporarily. In this manner, frequently reading webpage data by the client can be avoided, frequently writing the data into the data table by the client can also be avoided, and burden of data processing of the client can be reduced. On the other hand, in Step S1002 when the data table does not contain the pre-stored data item corresponding to the pre-stored identification item, Step S1002 and S1004 can be implemented to update the data table. Of course, this is an example for illustration purposes. Any suitable updating methods of the data table set based on the interactions between the client, webpage, and the network server can be included.

In various embodiments, the data item to be stored can be obtained from the webpage. For the current-accessed webpage, the obtaining process of the data item to be stored by the client is similar as a downloading process. Of course, the data item to be stored can be obtained from the already-accessed webpage, for example, can be exacted from the temporary file of the accessed webpage stored in the client. Note that, the client can obtain the data item to be stored by other suitable methods. For example, the data item to be stored can further be obtained from the network server by the client, to initialize or refresh the data table in the client, for example, to refresh the data table of the client on the server-side.

According to the disclosed method for accessing webpage, in Step S1004 the data item(s) to be stored obtained by the client can be used as pre-stored data item(s) and updated into data table, to realize the above-described updating of data table. For example, various suitable methods can be used to update the data item(s) to be stored into data table. It should be noted that, the terms “the data item(s) to be stored” and “the pre-stored data item(s)” are used for illustration purposes. In some cases, “the data item(s) to be stored” and “the pre-stored data item(s)” can be used for same data item(s). For example, for the pre-stored data item “Tom” in the Table 1, in one embodiment, the client can obtain this data item “Tom” from a webpage displaying information related to a first user; in another embodiment, the data item “Tom” can be used to form as the data item to be stored; in still another embodiment, when the data item “Tom” is stored in the data table of the client, this data item “Tom” can be used to form as the pre-stored data item. Note that the above differently-described one data item should not be understood as duplicated definition, but as a same object described to adapt to different stages during the disclosed implementation or process.

Of course, in one embodiment, it is not necessarily to maintain consistency between the data item to be stored with the pre-stored data item. For example, in some cases, the data item to be stored obtained by the client from the webpage may include the data item “Tom”, while the pre-stored data item stored in the data table may include the data item “nickname=Tom” from the processed data item to be stored. As such, in the step S104, the pre-stored data item may be entirely inserted or replaced into the first URL. Any suitable formats can be used for the “data items to be stored” and/or “the pre-stored data items” without limitation.

On the other hand, the updated data table can also be recorded with a corresponding relationship between the pre-stored identification items and the pre-stored data items such that, in Step S404, accurate calling of the pre-stored data items corresponding to the pre-stored identification items can be achieved. The corresponding relationship between the pre-stored identification items and the pre-stored data items may be realized by the consistency between variable names of the pre-stored data item and contents of the pre-stored identification items stored in the data table of Table 1. Other suitable implement methods can be used to realizing such corresponding relationship, e.g., as shown in the table data of Table 3. For example, in Table 3 can be used to present another sort of data table stored in local client and corresponding to a first user. When compared with Table 1 and Table 2, information loaded on the webpage corresponding to the pre-stored identification items and the pre-stored data items is omitted in Table 3. The first column of Table 3 is used to indicate variable names used by the pre-stored identification item.

TABLE 3

| | Pre-Stored | | |
|---|---|---|---|
| Variable Name of | Identification | Pre-Stored Data | Data Item |
| Identification Item | Item | Item | Variable Name |
| ID.ITEM1 | bl | 002 | uin.ITEM1.0 |
| | | 003 | uin.ITEM1.1 |
| ID.ITEM2 | age | 26 | uin.ITEM2 |

Note that, as shown in Table 3, the variable name of the pre-stored identification item in the data table may be formed by two sections: a first pre-stored identification item section and a second pre-stored identification item section. The second pre-stored identification item section of each variable name can be identified from the pre-stored identification item and the pre-stored data item. In other words, the data table uses the variable name to record the corresponding relationship between the pre-stored identification items and the pre-stored data items. Of course, this is only an exemplary embodiment and the present disclosure is not limited.

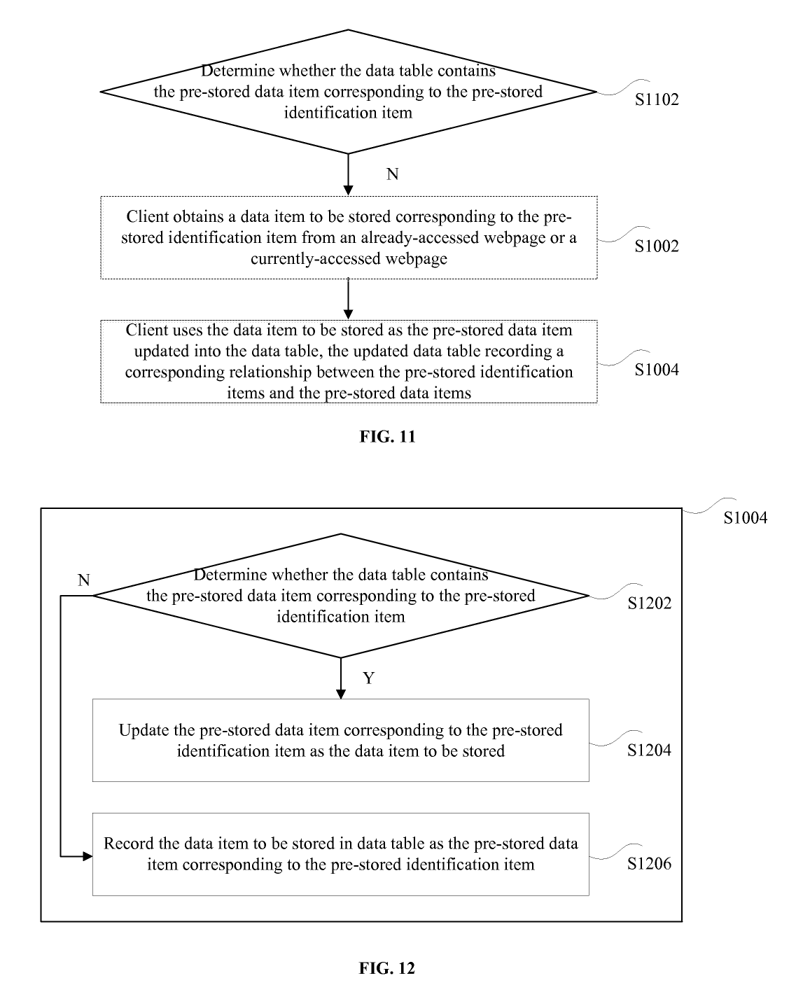

Specifically, as an optional implementing method, referring to FIG. 12, Step S1004 can include following exemplary steps. In Step S1202, it is determined whether the data table contains the pre-stored data item corresponding to the pre-stored identification item.

When it is determined that the data table contains the pre-stored data item, Step S1024 can be implemented. When it is determined that the data table does not contain the pre-stored data item, Step S1026 can be implemented.

In Step S1024, the pre-stored data item corresponding to the pre-stored identification item is updated as the data item to be stored.

In Step S1026, the data item to be stored in data table as the pre-stored data item corresponding is recorded into the pre-stored identification item.

In various embodiments, after obtaining the data item to be stored corresponding to the pre-stored identification item by Step S1002, Step S1202 of determining whether the data table contains the pre-stored data item corresponding to the pre-stored identification item can be implemented to select the updating method for the data table of the different data items to be stored. For example, the above method can be realized using any suitable methods: according to the corresponding relationship between the pre-stored data item and the pre-stored identification item, searching in the data table collection whether the pre-stored data item corresponding to some pre-stored identification item is contained. According to the searching result, Step S1204 or S1206 can be selected to implement. Specifically, for the data table of Table 1, Table 2, or Table 3, by searching keyword(s) of the variable name of the pre-stored data item, whether the data table contains the pre-stored data item corresponding to the pre-stored identification item can be determined.

In the circumstance of the data table containing the pre-stored data item corresponding to the pre-stored identification item, in Step S1204, the pre-stored data item corresponding to the pre-stored identification item can be updated as the data item to be stored. The updating method can include directly replacing the pre-stored data item as the data item to be stored. In other embodiments, the data item to be stored can be processed first, and then the processed data item can be replaced into the data table.

On the other hand, for the circumstance of the data table not containing the pre-stored data item corresponding to the pre-stored identification item, in Step S1206, the data item to be stored in data table can be recorded as the pre-stored data item corresponding to the pre-stored identification item. Similarly, the data item to be stored can be directly recorded into the data table. Or the data item to be stored can firstly be processed, and the processed data item can be replaced into the data table. Meanwhile, the corresponding relationship between the pre-stored data item and the pre-stored identification item can be recorded.

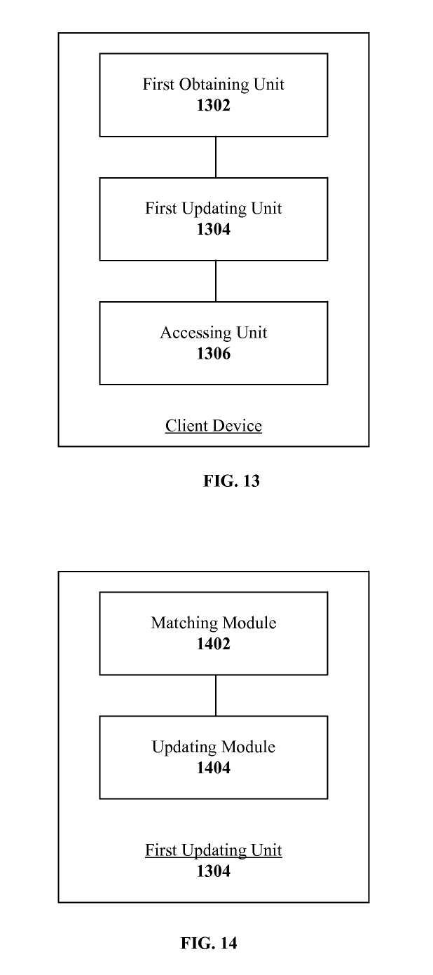

A client for accessing webpage is provided. Referring to FIG. 13, the exemplary client includes: a first obtaining unit 1302, a first updating unit 1304, and/or an accessing unit 1306.

The first obtaining unit 1302 is configured to obtain a first URL (uniform resource locator) according to a request for accessing a webpage. The first updating unit 1304 is configured to update the first URL to form a second URL. The second URL contains one or more pre-stored data items which are pre-stored in the client, and is configured to load information corresponding to the one or more pre-stored data items to the webpage to be accessed. The accessing unit 1306 is configured to access the webpage via the second URL.

According to the method for accessing webpage, the first obtaining unit 1302 can obtain can obtain the first URL according to the request for accessing webpage (or the webpage accessing request). Specifically, in a general condition, the request for accessing webpage can be shown as a clicked identification of a certain webpage link on the user interface provided by the client. For example, in various embodiments, the capture and identification of clicking by mouse on a section of texts having the URL hyperlink on the interface can form the request for accessing webpage, and the URL corresponding to the hyperlink can be truncated in the client as the first URL. Of course, the above-mentioned webpage link may not appear on the characters, but on other suitable user interface elements, for example icons, images, video pictures, etc.

However, methods for requesting to access the webpage and/or the method for obtaining the first URL are not limited and any suitable methods can be encompassed herein. For example, the methods for requesting to access the webpage can also include confirmation of the webpage address inputted in the address bar of the browser, while the client can read the webpage address as the first URL. In fact, in various embodiments, the request for accessing webpage may be independent from the signal from a computer inputting device and read by the client. For example, the request for accessing webpage can be automatically generated by running an application in the client, to form a popup-page on the client interface (for example, for accessing a navigation page) to obtain the URL of the popup-page as the first URL by the client. In various embodiments, the source of the request for accessing webpage may not be limited to the above-mentioned client for accessing the webpage. For example, under some environment for interactions between a client and a server, the request for accessing webpage may be from the server-side, and in this case, the first URL may be obtained from outside of the client.

According to the disclosed device for accessing webpage, the first updating unit 1304 may update the first URL to form the second URL. The second URL contains one or more pre-stored data items which are pre-stored in the client, and is configured to load information corresponding to the one or more pre-stored data items to the webpage to be accessed. For example, the above information may be the word information. In various embodiments, the client can directly update code of English character, or the Chinese character corresponding to the user ID into the first URL to form the second URL, by the first updating unit 1304, to display the user name or nickname in a pre-set location of the target webpage. However, in various embodiments, the above information can be configured including other types of information. For example, in a scenario, the client may update the configuration item code corresponding to the user configuration into the first URL. For example for a pre-set parameter that can be identified by the webpage, the parameter “0” is configured to denote white webpage background, the parameter “1” is configured to denote blue webpage background, and the parameter of “2” is configured to denote green webpage background. The above value item can further be transmitted to the webpage by the updated second URL to display the corresponding background color on the webpage. Of course, the above-described examples are for illustration purposes, other suitable examples can be encompassed without limitations.

It should be appreciated that, various suitable methods for updating the first URL for forming the second URL may be used without limitation. Note that the first URL and second URL described in the disclosure for illustration purposes. For example, a “first” and a “second” should be understood as a URL and another different URL. In some embodiments, only “URL” may be described, while no any “second URL” is described. The first URL can be replaced with “URL before update”, while the second URL can be replaced with “URL after update” or “updated URL”.

According to the disclosed client for accessing webpage, the accessing unit 1306 can access the webpage through the second URL. In some embodiments, the first URL and the second URL can point to a same webpage. In other embodiments, the first URL and the second URL can point to a different webpage. For example, after updating the path portion of the first URL, the webpage directed by the formed second URL can be different from the first URL. Note that the updating method of the first URL and the specific format of the second URL can be configured according to the processing requirement of the request for accessing webpage requested by the client.

As such, in various embodiments, different from directly using the first URL to access a webpage, the client can first locally update the first URL, (e.g., assign a value to one or more parameters of the first URL), after updating, then use the formed second URL to access the webpage. Because the webpage can directly read the parameter values from the second URL without temporarily establishing the data connection between the webpage and the network server to pull the corresponding webpage data, the burden of network server is decreased. Meanwhile, the response speed for accessing the webpage on the client-side is increased. In various embodiments, the first URL can further be updated through any other suitable methods to achieve the same or similar technology effect.

As described above, conventional methods include: the client submits a request for accessing a webpage to be accessed through a first URL, establishes data connection between the webpage and a server, and requests the server for information that the webpage needs to load; and the server pulls webpage data corresponding to information to be loaded through a CGI (Common Gateway Interface) interface or a CGI program, sends the pulled webpage data to the webpage, and sends the entire webpage to the client for the client to display in the browser.

As disclosed, FIG. 3 depicts an exemplary implementing environment for implementing a webpage accessing method consistent with various disclosed embodiments. For example, a client can access a webpage using the exemplary implementing environment in FIG. 3. In the method, the client obtains a first URL according to a request for accessing a webpage; requests and pulls the webpage data from the local data source management through the URL parser; updates the first URL according to the pulled webpage data to form the second URL through the URL parser; and/or submits a webpage accessing request through the second URL. The second URL contains information to be loaded by the webpage to be accessed corresponding to the webpage data.

Compared with conventional methods for accessing a webpage, in the disclosed methods for accessing a webpage, when the webpage is being accessed, the data connection between the webpage and the server in existing technology is eliminated, and the multiple data transmission participated by the server is also eliminated. The burden of the network server caused by client accessing webpage can be significantly decreased. This solves problems in conventional technology, which often cause the network server to be overloaded when obtaining webpage information through the network server. In addition, in various embodiments, the client can realize normal accessing to the webpage through the locally provided pre-stored data, while there is no need to wait for a long time for accomplishing data interactions used for transmitting the webpage information between the webpage and the network server in conventional technologies. The response time of the webpage to be accessed can be decreased.

Optionally, in various embodiments, referring to FIG. 14, the first updating unit 1304 includes: a matching module 1402 and/or an updating module 1404.

The matching module 1402 is configured to match a URL identification item of the first URL with the pre-stored identification items of a data table. The URL identification item is recorded inside or outside the first URL. The data table is pre-stored in the client. Each of the pre-stored identification items is individually stored in the data table or correspondingly stored in the data table corresponding to the one or more pre-stored data items.

The updating module 1404 is configured to update the pre-stored data item corresponding to the matched identification item of the data table into the first URL, when the pre-stored identification items contain an identification item matched with the URL identification item.

In one embodiment, the data table locally stored in the client can be used to store the pre-stored data item configured to update the first URL into the second URL as depicted in the first updating unit 1304. In addition to the pre-stored data item, the data table can be configured to store the pre-stored identification item having corresponding relationship with the pre-stored data item. Each of the pre-stored identification items may correspond to one or more pre-stored data items. In various embodiments, in the data table stored by the client, at a certain point/moment, a pre-stored data item corresponding to each of one or more of the pre-stored identification items may have a content that is empty. That is, at this point/moment, the data table does not contain the pre-stored data item corresponding to that one or more pre-stored identification items.

For better understanding, Table 1 shows a storage structure of the pre-stored identification item and the pre-stored data item in the data table. Table 1 is configured to show a sort of data table locally stored in the client and corresponding to a first user. The first column is configured to show the name of information loaded in the webpage to be accessed. The second column is configured to show the pre-stored identification item, the third column is configured to show the pre-stored data item, and the forth column is configured to show variable name corresponding to the pre-stored data item stored in the client.

In one embodiment, referring to the first column of Table 1, information loaded in the webpage to be accessed includes: Black List, Nick Name, Age, Zodiac, Background Music, etc. All these information can correspond to the first user with the user serial number of “001”.

In various embodiment, the information loaded in the webpage to be accessed corresponding to the pre-stored data item(s) may be various types. Such information loaded in the webpage can be characters, texts, audio files, and/or video files without limitations.

Optionally, referring to the second column of Table 1, the pre-stored identification item(s) respectively corresponding to the above information can be configured as: “b1”, “age”, “co”, “nickname”, and “bgm”.

As disclosed, the pre-stored identification item can be an English letter or combination of letters. Other suitable methods can be used. For example, the pre-stored identification item can include character(s) or character string(s) other than letter(s), for example, number(s), special character(s), and/or any combination of the above. The disclosure is not limited in any manner. In addition, as described above, the pre-stored identification item can be configured to be a character string corresponding to the information name loaded in the webpage. However, any suitable configuration regulation can be used for the pre-stored identification item(s). For example, in various embodiments, the “uni=001” can be stored in another data table as the pre-stored identification item, and the pre-stored data item shown in the third column of Table 1 can be stored in the same data table corresponding to the pre-stored data item, without limitations.

Optionally, referring to the third column of Table 1, the pre-stored data item corresponding to the pre-stored identification item can respectively be: “002”, “003”, “26”, “0”, “Tom”, and “a0b1c2”. The pre-stored data items “002” and “003”, corresponding to the pre-stored identification item of “b1”, can respectively be user serial numbers of the second user and the third user in the black list set by the first user.

The pre-stored data item of “26”, corresponding to the pre-stored identification item of “age”, can be the age of the first user. The pre-stored data item of “0”, corresponding to the pre-stored identification item of “co”, can be the zodiac of the first user. The numerical value from 0 to 11 can be used to denote twelve Zodiacs, respectively. For example, the numeric value “0” denotes Aquarius.

The pre-stored data item “Tom”, corresponding to the pre-stored identification item of “nickname”, can be a nickname of the first user. The pre-stored data item “a0b1c2”, corresponding to the pre-stored identification item of “bgm”, can be the file name of the background music set by the first user.

In various embodiments, the pre-stored data item may include various types. The pre-stored data item can be a numerical value, a character string, or other suitable data format, for example, Boolean quantity etc. In addition, as of the interaction between the client and the webpage, the pre-stored data item can be directly displayed on a page of the webpage, e.g., to show the data item of “26” denoting user age and the data item of “Tom” denoting user nickname, to give code for some webpage loading information that can be identified by the webpage, to show the data item of “0” denoting user Zodiac, to give the directive information of other sources to be called by the webpage, to show the data item of “a0b1c2” denoting the file name of the background music to be loaded by the webpage, and/or to show serial number(s) and accessing path(s) of files of other type or the data of the format stated and required by the data interactive interface standard.

On the other hand, referring to Table 1, the pre-stored identification item can correspond to one data item, and/or can correspond to multiple data items. For example, the pre-stored identification item “b1” can correspond to the data item of “002” and “003” simultaneously to show that the second user and the third user in the black list set by the first user. Further, the data item corresponding to the pre-stored identification item “b1” can include nicknames of the second user and the third user for the webpage to be accessed to simultaneously obtain and display the serial number and the nickname information of users in the black list. In addition, in various embodiments, the pre-stored identification item can be configured to have a user serial number of “001” for the first user, and a corresponding pre-stored data item can include collection of the data items shown by the third column of Table 1.

In various embodiments, the content of a pre-stored data item corresponding to one or more pre-stored identification items in the data table may be empty. For example, in some cases, in a data table similar to Table 1, identification item pre-set by the client (e.g., the pre-stored identification item shown in the second column of Table 1) can be included. But some of the pre-stored identification items (e.g., the identification item of “age” corresponding to user age) can correspond to data items that are still not downloaded into the client, such that the data table similar to Table 1 may not contain the pre-stored data item corresponding to the pre-stored identification item “age”. In this case, subsequent updating scheme to the pre-stored data item of this data table can be described in great details later in this disclosure.

Optionally, referring to the forth column of Table 1, the variable name used by the pre-stored data item stored in the client can be respectively configured to “uin.BL.0”, “uin.BL.1”, “uin.AGE”, “uin.CO”, “uin.NICKNAME”, and “uin.BGM”.

In various embodiments, the variable name used by the pre-stored data item can be divided into two or three sections. For example, the first section “uin” can be a numerical value that equal to the user serial number “001” of the first user, used to be differentiated from other pre-stored data items corresponding to other users (e.g., the second user or the third user) stored in other data tables. In this case, by identifying the first section of the variable name, the client can realize the accurate calling of the pre-stored data item corresponding to a certain user, and update the pre-stored data item into the first URL in Step S402. The second URL can be formed and used for loading corresponding information in the webpage to be accessed, such that response can be made to multiple different users through a same one webpage.

In the above-mentioned variable names, the second section can be denoted by a capital letter portion and can be of the same name as the pre-stored identification item corresponding to the pre-stored data item, to form a corresponding relationship between the pre-stored data item and the pre-stored identification item. Of course, the corresponding relationship between the pre-stored data item and the pre-stored identification item can be established by any other suitable methods without limitations.

The above-mentioned variable names can further include a third section, for example “0” and “1” in “uin.BL.0” and “uin.BL.1”, configured to direct to multiple pre-stored data items corresponding to a same one pre-stored identification item. In various embodiments, the variable names used by the pre-stored data items can further include more character strings without limitations.

Note that, in the above case, as the pre-stored identification item can be directly read from the variable names of variables valued from the pre-stored data item, the client may not need to assign a fixed storage space for the pre-stored identification item. This can increase the usage efficiency of the storage space. Of course, the described herein are examples for illustration purposes, various embodiments can include any other implement methods and their variables without limitation.

According to the disclosed method for accessing webpage, the matching module 1402 can match the URL identification item of the first URL with pre-stored identification items in the data table, the URL identification item may be configured to mark the data item to be replaced in the first URL. Generally, according to the above matching result, the data item which is successfully matched in the first URL can be used as the URL identification item. In some embodiments, the first URL can first be parsed according to the pre-set configuration to obtain the URL identification item. For example, according to the URL format, the first URL can be split to obtain the URL identification item.

On the other hand, the URL identification item can be located inside or outside of the first URL. In various embodiments, one portion of the URL identification item can be from the inside of the first URL, and another portion of the URL identification item can be from the outside of the first URL.

The matching module 1402 can directly match the first URL with the data table stored in the client to obtain the URL identification item that is inside of the first URL. Optionally, the matching module 1402 can implement the following exemplary steps.

When the first URL contains the URL character string having the same content with any of the URL identification item, it is determined that the pre-stored identification item contains the identification item matched with the URL identification item, and the identification item having the same content with the URL character string can be used as the matched identification item. When the first URL does not contain the URL character string having the same content with any of the URL identification item, it is determined that the pre-stored identification item does not contain the identification item matched with the URL identification item.

For example, for the data table in Table 1, the first URL is determined whether contains the character string same as the pre-stored identification item of “b1”, “age”, “co”, “nickname”, or “bmg” that are shown in the second column of Table 1. When the first URL contains the character string is determined, a successful matching is considered. The identification item having the same content with the URL character string is used as the matched identification item of URL identification item. The character string of the first URL can be used as the URL identification item, and further the location of the URL character string can be recorded in the first URL. Alternatively, according to the first URL character string, the first URL can be split into two sections before and after the character string. When the first URL does not contain the character string, it is considered the matching is unsuccessful. It can then be determined that the pre-stored identification item does not contain the matched identification item. Of course, for avoiding the misjudgment occurs due to use of pure letter identification item, the pre-stored identification item can be set as “b1=”, “age=”, “co=”, “nickname=” or “bgm=”, or the pre-stored identification item can be pre-processed during the matching process.

In addition, according to the determination result, by the matching module 1402, it is selected whether to implement the Steps for updating the pre-stored data item, by the updating module 1404, in the data table corresponding to the matched identification item into the first URL.

In various embodiments, the URL identification item can further be recorded in the outside of the first URL. The first obtaining unit 1302 is configured to obtain the first URL and the URL identification item corresponding to the first URL, according to the request for accessing the webpage.

Optionally, in addition to obtaining the first URL according to the request for accessing the webpage, the first obtaining unit 1302 can further obtain the other information corresponding to the request for accessing the webpage from the outside of the first URL. For example, the webpage to be accessed is configured to display related data of the first user, while when detecting the request for accessing the webpage, the first obtaining unit 1302 can obtain the user serial number of “001” corresponding to the first user outside of the obtained first URL, and use the serial number of “001” as the URL identification item, to match with the pre-stored identification item stored in the data table by the client. Of course, in various embodiments, the above two methods can be combined.

For example, as an optional implementing method, the obtained URL identification item outside of the first URL (e.g., the above-described user serial number of “001” corresponding to the first user) can be added into the first URL, or be combined with the first URL, and then matched with the pre-stored identification item of the data table, by the matching module 1402.

As another optional method, the matching module 1402 is configured: to determine that the pre-stored identification items have the matched identification item, and using the initially-matched identification item as the matched identification item, when the pre-stored identification items contain an initially-matched identification item matched with the URL identification item recorded outside of the first URL, and the first URL contains the URL identification item recorded in the first URL matched with the initially-matched identification item.

The matching module 1402 is configured to determine that the pre-stored identification items do not contain the matched identification item, when the pre-stored identification items do not contain the initially-matched identification item matched with the URL identification item recorded outside the first URL, or the first URL does not contain the URL identification item recorded in the first URL matched with the initially-matched identification item.

Table 2 is another exemplary data table corresponding to a first user having a serial number “001”, as similarly described in Table 1. In Table 2, the pre-stored identification item can be set as a structure including two sections, to realize the matching processes by the matching module 1402 for the URL identification item recorded inside and outside of the first URL.

In one embodiment, by the matching module 1402, the pre-stored identification item shown in the second column of Table 3 can be matched with the URL identification item recorded in the outside of the first URL, to obtain the initially matched identification item. Optionally, according to the first section (i.e., “001”) of the pre-stored identification item of the data table shown as Table 2, the pre-stored identification item can be matched with the URL identification item outside of the first URL. In a first scenario of this case, the URL identification item outside of the first URL obtained by the client can be “002”. No identification item matched with the URL identification item “002” can be found from the pre-stored identification items. That is, the initially matched identification item is not contained. In a second scenario of this case, the URL identification item outside of the first URL obtained by the client can be “001”, which matches with the pre-stored identification items “001.b1” and “001.age” in the data table shown in Table 2. The pre-stored identification items “001.b1” and “001.age” can then be marked as initially matched identification items.

In the above-mentioned second scenario, by the matching module 1402, the first URL can be matched with the initially matched identification item, i.e., the first URL can be matched with the above-mentioned initially matched identification items “001.b1” and “001.age”. Optionally, the second section of the above two identification items (i.e., “b1” and “age”) can be matched with the URL identification item of the first URL. As an optional method, it can be determined whether the first URL contains the character string the same as “b1” or “age”. When the first URL contains the character string, Step S706 can be implemented. When the first URL does not contain the character string, Step S708 can be implemented. Of course, for avoiding mis-determination, the first URL can further be determined whether contains the character string same as “b1=” or “age=”.

In addition, according to the determination result, it is selected whether to implement the steps for updating the pre-stored data item in the data table corresponding to the matched identification item into the first URL by the matching module 1402. Any suitable methods for matching the URL identification item with the pre-stored identification item may be used and encompassed. For example, the client can be pre-set according to specific applications.

According to the disclosed method for accessing webpage, when the pre-stored identification item contains the identification item matched with the URL identification item, the pre-stored identification item corresponding to the matched identification item of the data table can be updated into the first URL by the updating module 1404. It is noted that, the implementing condition of the updating module 1404 has a corresponding relationship with the matching result of the matching module 1402. That is, in the updating module 1404, according to the matching result of the matching module 1402, it can be selected whether to implement the Steps of updating the pre-stored data item corresponding to the matched identification item of the data table into the first URL.

It should be noted that, using the updating module 1404, the updated first URL can be directly used as the second URL, to implement the accessing of the webpage by the accessing module 1306. In other embodiments, the updated first URL can be further processed using any suitable methods.

On the other hand, in the updating module 1404, the operation of updating the pre-stored data item corresponding to the matched identification item in the data table into the first URL can be implemented by any suitable methods without limitations. For example, an exemplary method can include: updating an entire first URL (that is, according to the pre-stored data item corresponding to the matched identification item and the URL format, directly generating the second URL), and replacing the first URL with the second URL. Of course, other suitable implementing method can be used for the updating operation.

In various embodiments, the updating module 1404 is configured to: replace the initial data item of the first URL with the pre-stored data item corresponding to the matched identification item, when the first URL has an initial data item corresponding to the URL identification item; and configured to insert the pre-stored data item corresponding to the matched identification item to a location corresponding to the URL identification item in the first URL, when the first URL does not have the initial data item.

In various embodiments, the first URL can contain the URL identification item, but cannot contain the initial data item corresponding to one or more of the URL identification item. For example, the parameter portion of the first URL can include the character fragment in a format of “&parameter name=&”, where “&” is configured to show separation between these two parameters. In one exemplary scenario, when the character string corresponding to the “parameter name” has been stored in the data table of the client as one member of the pre-stored identification item, then after a successful matching by the matching module 1402, the portion of “parameter name” can be marked as the URL identification item. As the content of the data item corresponding to the first URL is empty, the updating module 1404 can determine the first URL does not contain the initial data item corresponding to the URL identification item.

In the above exemplary scenario, in the updating module 1404, the pre-stored data item corresponding to the matched identification item can be inserted into the location corresponding to the URL identification item in the first URL. For example, the pre-stored data item (e.g., “parameter values”) corresponding to the matched identification item in the data table can be inserted into a location (e.g., the location set after a first “=” after the “parameter name”) corresponding to the URL identification item of “parameter name” in the first URL. In various embodiments, the character string corresponding to “parameter name=” can be used as the pre-stored identification item to be stored in the data table. After a successful matching, the “parameter name=” can be marked as the URL identification item, such that the pre-stored data item of “parameter name” corresponding to the pre-stored identification item can be directly inserted after the URL identification item.

In addition, in various embodiments, the updating module 1404 is further configured: when the pre-stored data item corresponding to the matched identification item contains one data item, to insert the pre-stored data item corresponding to the matched identification item to the location corresponding to the matched identification item in the first URL; and when the pre-stored data item corresponding to the matched identification item contains multiple data items, according to the pre-stored data item corresponding to the matched identification item, to generate a character string complying with a URL format and inserting the character string into the first URL.

In one embodiment, the pre-stored data item corresponding to the pre-stored identification item may be one or more. Referring to Table 1, the pre-stored data item corresponding to the pre-stored identification item of “nickname” is one item: “Tom”. In one scenario, after the matching process in Step S402, the pre-stored identification item of “nickname” becomes the matched identification item, then the number “N” of the data item contained by the pre-stored data item corresponding to the matched identification item N=1.

In the above scenario, in the updating module 1404, the pre-stored data item corresponding to the matched identification item can be inserted into the location corresponding to the matched identification item in the first URL. Any suitable inserting method can be used herein.

Referring to Table 1, the pre-stored data item corresponding to the pre-stored identification item of “b1” has two items: “002” and “003”. In one scenario, after the matching process in Step S402, the pre-stored identification item of “b1” becomes the matched identification item, then the number “N” of the data item contained in the pre-stored data item corresponding to the matched identification item N=2.

In the updating module 1404, according to the pre-stored data item corresponding to the matched identification item, the character string complying with the URL format can be generated, and the character string can be inserted into the first URL. For example, according to the pre-stored data items of “002” and “003” corresponding to the matched identification item of “b1”, the character string (e.g., “&b1_{—}0=002&b1_{—}1=003”) complying with the URL format can be generated and inserted into the first URL, to form the second URL used for displaying the second user and the third user in the black list on the webpage to be accessed. For example, the generated character string complying with the URL format can further comply with the rule of data interactive interface standard for the second URL to be identified by the webpage. Of course, this is an example for illustration purposes. In various embodiments, the number “N” of the data item contained in the one or more pre-stored data items corresponding to the matched identification item can be N=3 or more.

On the other hand, in various embodiments, the first URL contains not only the URL identification item, but also the corresponding initial data item. For example, the path portion of the first URL can include “/folder name/request_uin/”, where “/” is configured to show a separation between the two path nodes, and “request_uin” can be pre-set character used for reading the user serial number. In one scenario, when the URL identification item recorded outside of the first URL obtained by the client has the user serial number “001” of the first user, and the URL identification item “001” has been stored in the data table of the client as one member of the pre-stored identification item. Then after a successful matching in Step S402, as the first URL contains the corresponding initial data item of “request_uin”, the initial data item of the first URL can be replaced with the pre-stored data item corresponding to the matched identification item.

In the updating module 1404, the initial data item of the first URL can be replaced with the pre-stored data item corresponding to the matched identification item. For example, the initial data item of “request_uin” can be replaced with the pre-stored data item of “001” corresponding to the matched identification item, to form the second URL including the “folder name/001” and to display information stored in the path corresponding to the first user in the webpage.

In one embodiment, the pre-stored data item can be same as the pre-stored identification item, for example, the same as “001”, to practically realize the importing the information from the URL identification item recorded outside of the first URL into the first URL.

Further, in various embodiments, based on different URL identification items (e.g., “002” or “003”) obtained by the client, the initial data item is replaced to form the second URL, which indeed points out the webpages under different paths. Such webpages can use the same source code, which may be called a same page or a different page without limitations.

It should be appreciated that the above described implementing environment may be modified or altered. Generally, in one embodiment, the first URL may contain a URL identification item, and/or may contain URL identification items that are not obtained by the first obtaining unit 1302 or the matching unit 1402 in the client. Further, in a case that a URL contains URL identification item, the URL may or may not contain initial data items corresponding to the URL identification items. A portion of the URL identification item(s) may contain corresponding initial data item, while another portion of the URL identification item(s) may not contain corresponding initial data item, without limitation.

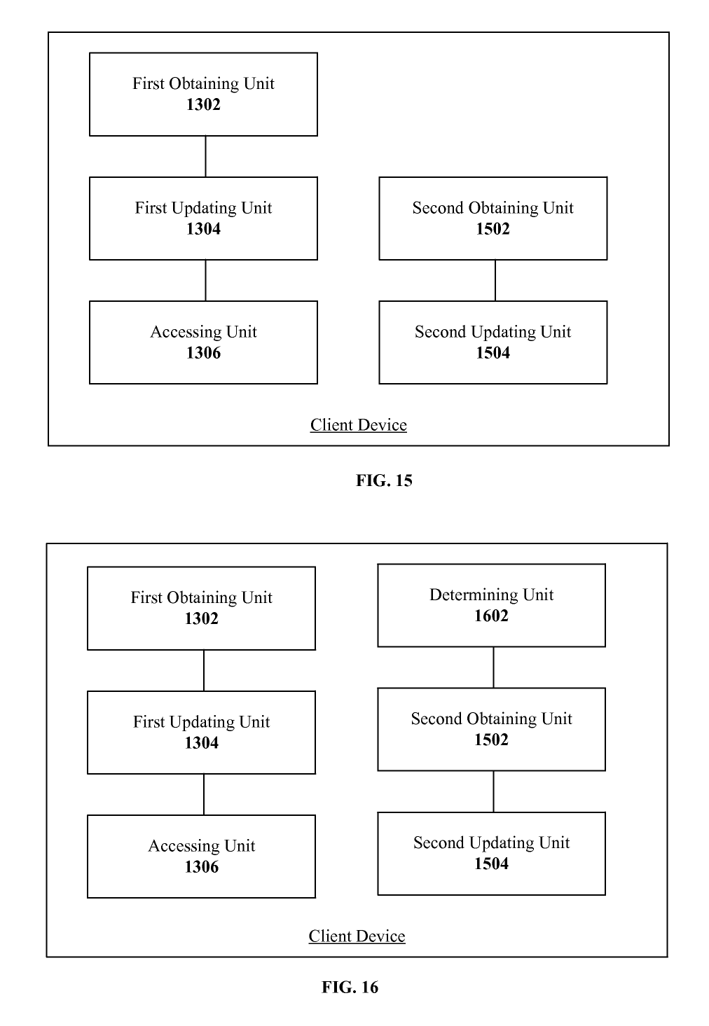

Optionally, referring to FIG. 15, the client provided by various embodiments further includes: a second obtaining unit 1502 and/or second updating unit 1504. The second obtaining unit 1502 is configured to obtain a data item to be stored corresponding to the pre-stored identification item from an already-accessed webpage or a currently-accessed webpage.

The second updating unit 1504 is configured to use the data item to be stored as the pre-stored data item updated into the data table. The updated data table records a corresponding relationship between the pre-stored identification items and the pre-stored data items.

According to the disclosed client for accessing webpage, using the second obtaining unit 1502, the data item to be stored corresponding to the pre-stored identification stored in the data table by the client can be obtained from the already-accessed webpage or the currently-accessed webpage by the client. For example, the data item to be stored can be further configured to denote the data item to be stored into the data table of the client, to initialize or refresh the pre-stored data item of the data table by the second updating unit 1504. Similar to the pre-stored data item depicted in Table 1, the data item to be stored may include multiple types, for example Boolean quantity, numerical value, character string, etc.

In the example of Table 1, in one scenario, when the pre-stored data item of the data table shown in Table 1 is empty, i.e., the data table does not contain the data item corresponding to the pre-stored identification shown by the second column of Table 1, the client can pull the data item corresponding to the pre-stored identification item from the webpage by the second obtaining unit 1502 as the data item to be stored, and by the second updating unit 1504, the data item to be stored pulled from the webpage can be used as the pre-stored data item to add into the data table. The data table can then be improved to be more complete such that, when accessing the webpage according to the disclosed method for accessing webpage, a successful calling of the pre-stored data item can then be realized by the updating module 1404. In one embodiment, the implementing condition by the second obtaining unit 1502 and the second updating unit 1504 can further be set as any suitable conditions or no implementing condition is set to obtain the data corresponding to the pre-stored identification item of the data table from each webpage accessed by the client, and/or to refresh the data table according to the data item to be stored obtained from each accessing.

Specifically, as an optional starting condition, referring to FIG. 16, the client further includes: a determining unit 1602. The determining unit 1602 is configured to determine whether the data table contains the pre-stored data item corresponding to the pre-stored identification items.

When the determining unit 1602 determines data table contains the pre-stored data item corresponding to the pre-stored identification item, i.e., the pre-stored data item may not be updated temporarily. In this manner, frequently reading webpage data by the client can be avoided, frequently writing the data into the data table by the client can also be avoided, and burden of data processing of the client can be reduced. On the other hand, when the determining unit 1602 determines the data table does not contain the pre-stored data item corresponding to the pre-stored identification item, the second obtaining unit 1502 and the second updating unit 1504 can be implemented to update the data table. Of course, this is an example for illustration purposes. Any suitable updating methods of the data table set based on the interactions between the client, webpage, and the network server can be included.

In various embodiments, the data item to be stored can be obtained from the webpage. For the current-accessed webpage, the obtaining process of the data item to be stored by the client is similar as a downloading process. Of course, the data item to be stored can be obtained from the already-accessed webpage, for example, can be exacted from the temporary file of the accessed webpage stored in the client. Note that, the client can obtain the data item to be stored by other suitable methods. For example, the data item to be stored can further be obtained from the network server by the client, to initialize or refresh the data table in the client, for example, to refresh the data table of the client on the server-side.

According to the disclosed client, in the second updating unit 1504, the data item(s) to be stored obtained by the client can be used as pre-stored data item(s) and updated into data table, to realize the above-described updating of data table. For example, various suitable methods can be used to update the data item(s) to be stored into data table. It should be noted that, the terms “the data item(s) to be stored” and “the pre-stored data item(s)” are used for illustration purposes. In some cases, “the data item(s) to be stored” and “the pre-stored data item(s)” can be used for same data item(s). For example, for the pre-stored data item “Tom” in the Table 1, in one embodiment, the client can obtain this data item “Tom” from a webpage displaying information related to a first user; in another embodiment, the data item “Tom” can be used to form as the data item to be stored; in still another embodiment, when the data item “Tom” is stored in the data table of the client, this data item “Tom” can be used to form as the pre-stored data item. Note that the above differently-described one data item should not be understood as duplicated definition, but as a same object described to adapt to different stages during the disclosed implementation or process.

Of course, in one embodiment, it is not necessarily to maintain consistency between the data item to be stored with the pre-stored data item. For example, in some cases, the data item to be stored obtained by the client from the webpage may include the data item “Tom”, while the pre-stored data item stored in the data table may include the data item “nickname=Tom” from the processed data item to be stored. As such, in the updating module 1404, the pre-stored data item may be entirely inserted or replaced into the first URL. Any suitable formats can be used for the “data items to be stored” and/or “the pre-stored data items” without limitation.

On the other hand, the updated data table can also be recorded with a corresponding relationship between the pre-stored identification items and the pre-stored data items such that, in the updating module 1404, accurate calling of the pre-stored data items corresponding to the pre-stored identification items can be achieved. The corresponding relationship between the pre-stored identification items and the pre-stored data items may be realized by the consistency between variable names of the pre-stored data item and contents of the pre-stored identification items stored in the data table of Table 1. Other suitable implement methods can be used to realizing such corresponding relationship, e.g., as shown in the table data of Table 3. For example, in Table 3 can be used to present another sort of data table stored in local client and corresponding to a first user. When compared with Table 1 and Table 2, information loaded on the webpage corresponding to the pre-stored identification items and the pre-stored data items is omitted in Table 3. The first column of Table 3 is used to indicate variable names used by the pre-stored identification item.

Note that, as shown in Table 3, the variable name of the pre-stored identification item in the data table may be formed by two sections: a first pre-stored identification item section and a second pre-stored identification item section. The second pre-stored identification item section of each variable name can be identified from the pre-stored identification item and the pre-stored data item. In other words, the data table uses the variable name to record the corresponding relationship between the pre-stored identification items and the pre-stored data items. Of course, this is only an exemplary embodiment and the present disclosure is not limited.

Specifically, as an optional implementing method, the second updating unit 1504 is configured: to record the data item to be stored as the pre-stored data item corresponding to the pre-stored identification item in the data table, when the data table does not contain the pre-stored data item corresponding to the pre-stored identification items; and to update the pre-stored data item corresponding to the pre-stored identification items as the data item to be stored, when the data table contains the pre-stored data item corresponding to the pre-stored identification items.

In various embodiments, after obtaining the data item to be stored corresponding to the pre-stored identification item by the second obtaining unit 1502, determining whether the data table contains the pre-stored data item corresponding to the pre-stored identification item can be implemented to select the updating method for the data table of the different data items to be stored. For example, the above method can be realized using any suitable methods: according to the corresponding relationship between the pre-stored data item and the pre-stored identification item, searching in the data table collection whether the pre-stored data item corresponding to some pre-stored identification item is contained. According to the searching result, Step S1204 or S1206 can be selected to implement. Specifically, for the data table of Table 1, Table 2, or Table 3, by searching keyword(s) of the variable name of the pre-stored data item, whether the data table contains the pre-stored data item corresponding to the pre-stored identification item can be determined.

In the circumstance of the data table containing the pre-stored data item corresponding to the pre-stored identification item the pre-stored data item corresponding to the pre-stored identification item can be updated as the data item to be stored. The updating method can include directly replacing the pre-stored data item as the data item to be stored. In other embodiments, the data item to be stored can be processed first, and then the processed data item can be replaced into the data table.

On the other hand, for the circumstance of the data table not containing the pre-stored data item corresponding to the pre-stored identification item, in the second updating unit 1504, the data item to be stored in data table can be recorded as the pre-stored data item corresponding to the pre-stored identification item. Similarly, the data item to be stored can be directly recorded into the data table. Or the data item to be stored can firstly be processed, and the processed data item can be replaced into the data table. Meanwhile, the corresponding relationship between the pre-stored data item and the pre-stored identification item can be recorded.

It should be noted that, in the present disclosure each embodiment is progressively described, i.e., each embodiment is described and focused on difference between embodiments. Similar and/or the same portions between various embodiments can be referred to with each other. In addition, exemplary devices are described with respect to corresponding methods.

The disclosed methods and/or devices can be implemented in a suitable computing environment. The disclosure can be described with reference to symbol(s) and step(s) performed by one or more computers, unless otherwise specified. Therefore, steps and/or implementations described herein can be described for one or more times and executed by computer(s). As used herein, the term “executed by computer(s)” includes an execution of a computer processing unit on electronic signals of data in a structured type. Such execution can convert data or maintain the data in a position in a memory system (or storage device) of the computer, which can be reconfigured to alter the execution of the computer as appreciated by those skilled in the art. The data structure maintained by the data includes a physical location in the memory, which has specific properties defined by the data format. However, the embodiments described herein are not limited. The steps and implementations described herein may be performed by hardware.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

As used herein, the term “module” can be software objects executed on a computing system. A variety of components described herein including elements, modules, units, engines, and services can be executed in the computing system. The methods and/or devices can be implemented in a software manner. Of course, the methods and/or devices can be implemented using hardware. All of which are within the scope of the present disclosure.

In various embodiments, the disclosed modules can be configured in one apparatus (e.g., a processing unit) or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods and/or devices. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes a . . . ” does not exclude other elements included in the process, method, article, or apparatus having those elements.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

As disclosed, in an exemplary environment for implementing a webpage accessing method, a client obtains a first URL according to a request for accessing a webpage; requests and pulls the webpage data from the local data source management through the URL parser; updates the first URL according to the pulled webpage data to form the second URL through the URL parser; and/or submits a webpage accessing request through the second URL. The second URL contains information to be loaded by the webpage to be accessed corresponding to the webpage data.

In the disclosed methods for accessing a webpage, when the webpage is being accessed, the data connection between the webpage and the server in existing technology is eliminated, and the multiple data transmission participated by the server is also eliminated. The burden of the network server caused by client accessing webpage can be significantly decreased. This solves problems in conventional technology, which often cause the network server to be overloaded when obtaining webpage information through the network server. In addition, the client can realize normal accessing to the webpage through the locally provided pre-stored data, while there is no need to wait for a long time for accomplishing data interactions used for transmitting the webpage information between the webpage and the network server in conventional technologies. The response time of the webpage to be accessed can be decreased.

What is claimed is:

1. A method for accessing a webpage, comprising:
obtaining, by a client, a first URL (uniform resource locator) according to a request for accessing a webpage;
updating, by the client, the first URL to generate a second URL, wherein the second URL contains one or more pre-stored data items which are pre-stored in the client, and the second URL is configured to load information corresponding to the one or more pre-stored data items to the webpage to be accessed; and
accessing, by the client, the webpage via the second URL.

2. The method according to claim 1, wherein updating the first URL includes:
matching a URL identification item of the first URL with pre-stored identification items of a data table, wherein the URL identification item is recorded inside or outside the first URL, the data table is pre-stored in the client, each of the pre-stored identification items is individually stored in the data table or correspondingly stored in the data table corresponding to the one or more pre-stored data items; and
updating the pre-stored data item corresponding to the matched identification item of the data table into the first URL, when the pre-stored identification items contain an identification item matched with the URL identification item.

3. The method according to claim 2, wherein the URL identification item is recorded inside the first URL, and wherein the matching of the URL identification item of the first URL with the pre-stored identification items in the data table includes:
when the first URL contains a URL character string having a same content with any of the pre-stored identification items, determining that the pre-stored identification items contain the matched identification item, and using the pre-stored identification item having the same content with the URL character string as the matched identification item, or
when the first URL does not contain the URL character string having the same content with any of the pre-stored identification items, determining that the pre-stored identification items do not contain the matched identification item.

4. The method according to claim 2, wherein the URL identification item is recorded outside the first URL, and wherein the matching of the URL identification item of the first URL with the pre-stored identification items in the data table includes:
when the pre-stored identification items contain an initially-matched identification item matched with the URL identification item recorded inside of the first URL, and the first URL contains the URL identification item recorded in the first URL matched with the initially-matched identification item, determining that the pre-stored identification items have the matched identification item, and using the initially-matched identification item as the matched identification item, or
when the pre-stored identification items do not contain the initially-matched identification item matched with the URL identification item recorded inside the first URL, or the first URL does not contain the URL identification item recorded in the first URL matched with the initially-matched identification item, determining that the pre-stored identification items do not have the matched identification item.

5. The method according to claim 2, wherein the URL identification item is recorded inside the first URL, wherein the step of updating the pre-stored data item corresponding to the matched identification item of the data table into the first URL includes:
when the first URL has an initial data item corresponding to the URL identification item, replacing the initial data item of the first URL with the pre-stored data item corresponding to the matched identification item; and
when the first URL does not have the initial data item, inserting the pre-stored data item corresponding to the matched identification item to a location corresponding to the URL identification item in the first URL.

6. The method according to claim 2, wherein the URL identification item is recorded outside the first URL, and wherein the step of obtaining, by the client, the first URL according to the request for accessing the webpage includes:
according to the request for accessing the webpage, obtaining, by the client, the first URL and the URL identification item corresponding to the first URL; and
wherein the step of updating the pre-stored data item corresponding to the matched identification item of the data table into the first URL includes:
when the first URL has the initial data item corresponding to the URL identification item, replacing the initial data item of the first URL with the pre-stored data item corresponding to the matched identification item; or
when the first URL does not have the initial data item, inserting the pre-stored data item corresponding to the matched identification item to a location corresponding to the URL identification item in the first URL.

7. The method according to claim 5, wherein the step of inserting the pre-stored data item corresponding to the matched identification item to the location corresponding to the URL identification item in the first URL includes:
when the pre-stored data item corresponding to the matched identification item contains one data item, inserting the pre-stored data item corresponding to the matched identification item to the location corresponding to the matched identification item in the first URL; and
when the pre-stored data item corresponding to the matched identification item contains multiple data items, according to the pre-stored data item corresponding to the matched identification item, generating a character string complying with a URL format and inserting the character string into the first URL.

8. The method according to claim 6, wherein before matching the URL identification item of the first URL with the pre-stored identification items of the data table, the method further includes:
obtaining, by the client, a data item to be stored corresponding to the pre-stored identification item from an already-accessed webpage or a currently-accessed webpage; and
using the data item to be stored as the pre-stored data item updated into the data table, wherein the updated data table records a corresponding relationship between the pre-stored identification items and the pre-stored data items.

9. The method according to claim 8, wherein the step of using the data item to be stored as the pre-stored data item updated into the data table includes:
when the data table does not contain the pre-stored data item corresponding to the pre-stored identification items, recording the data item to be stored as the pre-stored data item corresponding to the pre-stored identification item in the data table; or
when the data table contains the pre-stored data item corresponding to the pre-stored identification items, updating the pre-stored data item corresponding to the pre-stored identification items as the data item to be stored.

10. The method according to claim 2, wherein before the step of matching the URL identification item of the first URL with the pre-stored identification items of the data table, the method further includes:
determining whether the data table contains the pre-stored data item corresponding to the pre-stored identification items; and
when the data table does not contain the pre-stored data item corresponding to the pre-stored identification items, obtaining, by the client, the data item to be stored corresponding to the pre-stored identification items from the already-accessed webpage or the currently-accessed webpage and using the data item to be stored as the pre-stored data item updated into the data table, wherein the updated data table records the corresponding relationship between the pre-stored identification items and the pre-stored data items.

11. A client device comprising:
a first obtaining unit, configured to obtain a first URL according to a request for accessing a webpage;
a first updating unit, configured to update the first URL to form a second URL, wherein the second URL contains one or more pre-stored data items which are pre-stored in the client, and is configured to load information corresponding to the one or more pre-stored data items to the webpage to be accessed; and
an accessing unit, configured to access the webpage via the second URL.

12. The device according to claim 11, wherein the first updating unit includes:
a matching module, configured to match a URL identification item of the first URL with pre-stored identification items of a data table, wherein the URL identification item is recorded inside or outside the first URL, the data table is pre-stored in the client, and each of the pre-stored identification items is individually stored in the data table or correspondingly stored in the data table corresponding to the one or more pre-stored data items; and
an updating module, configured to update the pre-stored data item corresponding to the matched identification item of the data table into the first URL, when the pre-stored identification items contain an identification item matched with the URL identification item.

13. The device according to claim 12, wherein the URL identification item is recorded inside the first URL, and wherein the matching module is configured:
to determine that the pre-stored identification items contain the matched identification item, and use the pre-stored identification item having the same content with the URL character string as the matched identification item, when the first URL contains a URL character string having a same content with any of the pre-stored identification items; and
to determine that the pre-stored identification items do not contain the matched identification item, when the first URL does not contain the URL character string having the same content with any of the pre-stored identification items.

14. The device according to claim 12, wherein the URL identification item is recorded outside the first URL, and wherein the matching module is configured:
to determine that the pre-stored identification items have the matched identification item, and use an initially-matched identification item as the matched identification item, when the pre-stored identification items contain the initially-matched identification item matched with the URL identification item recorded inside the first URL, and the first URL contains the URL identification item recorded in the first URL matched with the initially-matched identification item; and
to determine that the pre-stored identification items do not have the matched identification item, when the pre-stored identification items do not contain the initially-matched identification item matched with the URL identification item recorded outside the first URL, or the first URL does not contain the URL identification item recorded in the first URL matched with the initially-matched identification item.

15. The device according to claim 12, wherein the URL identification item is recorded inside the first URL, and wherein the updating module is configured:
to replace an initial data item of the first URL with the pre-stored data item corresponding to the matched identification item, when the first URL has the initial data item corresponding to the URL identification item; and
to insert the pre-stored data item corresponding to the matched identification item to a location corresponding to the URL identification item in the first URL, when the first URL does not have the initial data item.

16. The device according to claim 12, wherein the URL identification item is recorded outside the first URL, and wherein a first obtaining unit is configured to obtain the first URL and the URL identification item corresponding to the first URL, according to the request for accessing the webpage; and
wherein the updating module is configured to replace the initial data item of the first URL with the pre-stored data item corresponding to the matched identification item, when the first URL has the initial data item corresponding to the URL identification item; and to insert the pre-stored data item corresponding to the matched identification item to a location corresponding to the URL identification item in the first URL, when the first URL does not have the initial data item.

17. The device according to claim 15, wherein the updating module is configured:
to insert the pre-stored data item corresponding to the matched identification item to the location corresponding to the matched identification item in the first URL, when the pre-stored data item corresponding to the matched identification item contains one data item; and
to generate a character string complying with a URL format, and insert the character string into the first URL, according to the pre-stored data item corresponding to the matched identification item, when the pre-stored data item corresponding to the matched identification item contains multiple data items.

18. The device according to claim 16, further including:
a second obtaining unit, configured to obtain a data item to be stored corresponding to the pre-stored identification item from an already-accessed webpage or a currently-accessed webpage; and
a second updating unit, configured to use the data item to be stored as the pre-stored data item updated into the data table, wherein the updated data table records a corresponding relationship between the pre-stored identification items and the pre-stored data items.

19. The device according to claim 18, wherein the second updating unit is configured:
to record the data item to be stored as the pre-stored data item corresponding to the pre-stored identification item in the data table, when the data table does not contain the pre-stored data item corresponding to the pre-stored identification items; and
to update the pre-stored data item corresponding to the pre-stored identification items as the data item to be stored, when the data table contains the pre-stored data item corresponding to the pre-stored identification items.

20. The device according to claim 12, further including:
a determining unit, configured to determine whether the data table contains the pre-stored data item corresponding to the pre-stored identification items;
a second obtaining unit, configured to obtain the data item to be stored corresponding to the pre-stored identification items from the already-accessed webpage or the currently-accessed webpage, when the data table does not contain the pre-stored data item corresponding to the pre-stored identification items; and
a second updating unit, configured to use the data item to be stored as the pre-stored data item updated into the data table, wherein the updated data table records the corresponding relationship between the pre-stored identification items and the pre-stored data items.
